(19) United States
(12) Patent Application Publication
(10) Pub. No.: US 2024/0145661 A1
(43) Pub. Date: May 2, 2024

(54) METHOD OF MANUFACTURING ANODE ELECTRODE FOR LITHIUM METAL BATTERY USING IRRADIATION OF PHOTOELECTROMAGNETIC ENERGY AND ANODE ELECTRODE FOR LITHIUM METAL BATTERY

(71) Applicants: VITZROCELL CO. LTD., Dangjin-si, Chungcheongnam-do (KR); MAKESENS INC., Calgary, Alberta (CA)

(72) Inventors: Simon PARK, Calgary, Alberta (CA); Chaneel PARK, Calgary, Alberta (CA); Hongseok CHO, Calgary, Alberta (CA); Jong-Song KIM, Dangjin-si, Chungcheongnam-do (KR); Kyoung-Soo PARK, Dangjin-si, Chungcheongnam-do (KR); Ji-Hoon KANG, Dangjin-si, Chungcheongnam-do (KR)

(21) Appl. No.: 18/282,271

(22) PCT Filed: Mar. 15, 2022
(86) PCT No.: PCT/KR2022/003612

§ 371 Date: Sep. 15, 2023

Related U.S. Application Data
(60) Provisional application No. 63/161,434, filed on Mar. 15, 2021.

(30) Foreign Application Priority Data
Mar. 4, 2022 (KR) 10-2022-0028234

(51) Int. Cl. H01M 4/04; H01M 4/38; H01M 4/62

(52) U.S. Cl. CPC H01M 4/0404; H01M 4/0471; H01M 4/382; H01M 4/622; H01M 4/625; H01M 2004/027

(57) ABSTRACT

The present disclosure relates to a lithium metal anode electrode that suppresses the growth of lithium dendrites which may deteriorate the electrochemical performance of a battery and cause catastrophic damage to a battery structure, and in particular, a method of manufacturing an anode electrode having a three-dimensional highly porous structure or a metal-or-carbon-based three-dimensional network structure, including irradiation of photoelectromagnetic energy.

### TECHNICAL FIELD

Disclosed herein are an anode electrode for lithium metal batteries and a method of manufacturing the same.

Specifically, the method of manufacturing an anode electrode for lithium metal batteries disclosed herein comprises creating three-dimensional structures on substrates via irradiation of photoelectromagnetic energy to substantially increase the surface areas of anode electrodes, enhancing the diffusion of lithium ions, reducing interfacial resistance, and suppressing the growth of lithium dendrites.

The method of manufacturing an anode electrode for a lithium metal battery in one embodiment includes creating a three-dimensional structure on a lithium metal substrate. The three-dimensional structure can be a layer of a nanoporous structure of conductive polymer nanocomposites or a three-dimensional structure of a carbon framework. The method of manufacturing an anode electrode for a lithium metal battery in another embodiment includes creating a three-dimensional porous structure of lithium metal comprised of copper-silver-carbon nanotubes coated directly on a current collector.

### BACKGROUND ART

Increasing market demand for rechargeable batteries with high energy density has led to a search for new anode materials that could replace conventional graphite anodes. Among various candidates, lithium metal has been a promising anode material for rechargeable lithium batteries because of its high theoretical specific capacity (3,860 mAh/g) and low density (0.59 g/cm³). However, despite the advantages, some critical challenges hinder the large-scale application of lithium metal anodes in lithium rechargeable batteries: one being the enormous volumetric change during the lithiation cycle, and the other being the growth of lithium dendrites.

Lithium dendrites are metallic microstructures formed on an anode during the charging process. It forms when extra lithium ions accumulate on the anode surface due to a difference in electrodeposition speed and grow in a repeated deposition/dissolution process. The growth of lithium dendrites can pierce a separator and cause an internal short circuit, damaging a battery and leading to catastrophic failure causing a fire or an explosion.

Dendrites grow from nucleation points on the lithium metal surface as lithium electroplates over the usage of the battery. Lithium dendrites can break off and result in irreversible lithium, reducing the battery capacity. In extreme cases, lithium dendrites grow to a point where it damages the separator by connecting a cathode and an anode forming short circuits which lead to a fire or even an explosion. The growth of lithium dendrites or volume change in the lithium metal anode during charging and discharging cycles can cause physical damage, delamination, and the breaking-off of a solid electrolyte interphase (SEI) layer. This leads to a continuous reaction between the lithium metal anode and the electrolyte to form a new SEI layer, consuming the electrolyte.

Understanding Formation of Lithium Dendrites

Numerous efforts have been made to solve the challenges associated with lithium metal batteries and understand the mechanisms of the formation and growth of lithium dendrites. Generally, lithium dendrites result from uneven lithium deposition caused by uneven charge distribution. For example, a rough surface on the current collector could also cause a concentrated ion flux around the tip of the rough surface, allowing faster lithium-ion deposition around a peak leading to the formation of dendrites. The points of dendrites' growth, such as the tip of the rough surface, are called nucleation points.

In theory, several models suggest the growth of lithium dendrites. The Chazlviel model [Chazlviel 1990] proposed that the existence of space charges due to the depletion of anions near the surface of the anode causes the formation of lithium dendrites. The model explained the growth rate of dendrites regarding the mobility of ions and the electric field. The onset time of dendrites followed Sand's time equation, where an increase in current density shortens the onset time of dendrites.

Another model proposed by Monroe and Newman [Monroe and Newman 2003] suggested that the growth of dendrites is dependent on the elasticity of separators and applies to lithium metal batteries with solid electrolytes. The model suggests that the growth of dendrites can be avoided if the mechanical strength of the electrolytes were high enough. However, this is not a practical solution because electrolytes with such high modulus could reduce ionic conductivity and impede a proper battery cycling function.

Methods of Suppressing Dendrites: Electrochemically Stable Electrolytes

Many other models mentioned earlier improved upon them by providing fundamental ideas to suppress the growth of lithium dendrites. One approach involves using more electrochemically stable electrolytes, such as an anion-tethered hybrid electrolyte, or especially using an anionic liquid-nanoparticle hybrid electrolyte. One example of such ionic liquid is 1-methyl-3-propylimidazolium (IM) TFSI [Lu et al. 2014]. The aforementioned electrolytes are electrochemically stable, non-flammable, and have a high dielectric constant. Their electrochemical stability comes from the unique structure where anions are linked to cations which are anchored covalently with inorganic particles. Following Sand's time model, the onset of dendrites takes an infinite amount of time when the anions are immobilized in such a case.

Several techniques are suggested to prevent or suppress the growth of dendrites in lithium metal anodes, including the optimization of the electrolytes. However, such methods affect the electrochemical properties of the batteries. Another method of suppressing the growth of dendrites is to fabricate an additional protective layer on the anode surface to form a stable solid electrolyte interphase (SEI) layer. Several studies found that three-dimensional structures could regulate consistent growth by evenly distributing nucleation points across their entire surface, inducing uniform lithium deposition across the anode instead of forming dendrites. Studies also showed that such a structure reduces local current density which prevents the formation of lithium dendrites.

The three-dimensional structures can be created using various materials, including 3D carbon paper, carbon nanotubes, carbon fibers, conductive polymer nanocomposites, metal fibers, or even lithium metal itself.

Lithium Metal Anode Electrode, U.S. Ser. No. 10/483,534B2

The document relates to an anode electrode comprised of two different layers, i.e., a lithium metal layer and a porous conductive layer. First, the porous conductive layer may contain two layers of a current collector and a conduction loading layer, both of which have multiple pores. It may be made of various materials and formed into a permeable grid, mesh, and rod structure; or a combination thereof. The porous conductive layer provides a larger surface area for the deposition of lithium and forms a stable SEI to reduce the formation of lithium dendrites. Moreover, the lithium dendrites grow from or become closer to the lithium metal surface and the separator due to the porous conductive layer. In addition, the electrical conductivity of the anode becomes more uniform for the lithium dendrites to reduce.

The document deals with the fundamental structure of a three-dimensional structure coated on a lithium metal anode to suppress the growth of dendrites and prevent catastrophic failure. However, it suggests no three-dimensional conductive structure.

Lithium Metal Protective Layer, Preparation Method thereof and Battery with Same, CN111490252A

The document relates to a porous protective layer for a lithium metal anode. The protective layer generates uniformly dispersed lithium alloy or lithium nitride, enhancing lithium-ion diffusion capacity and inhibiting the generation of lithium dendrites. In the method, cost-efficient materials are used to coat the lithium metal anode in a slurry and are then dried to form a protective layer. Materials for the protective layer include a metal compound, a conductive agent, and a binder; the metal compound is either metal nitride, aluminum oxide, aluminum fluoride, or non-lithiated tetra-aluminum. The document suggests a process of creating the porous structure on the lithium metal anode in detail but is limited to a simple deposition process of slurry and a simple drying process.

Surface Modification of Lithium Metal Electrode, DE102013114233A1

The document suggests a direct modification of a lithium metal anode (or another metal anode) surface structure to suppress the growth of lithium dendrites. Different geometrics of recesses, i.e., blind-hole-like recesses and cone-shaped recesses are created on the surface of the metal anode during the process. The recesses are rectangular, trapezoidal, dome, or triangular-shaped cross-sections. In the forming process, desired geometries of recesses are created with calender rolls by a microneedle roller or by a laser. The sides of the recesses are specially grooved in the forming process when soft metal such as lithium metal is used.

The recesses formed on the metal anode increase the surface area of the electrode. The larger surface area improves the discharge rate, charging rate, and cycle stability, and eventually decreases interfacial resistance. Furthermore, the improved cycle stability directly relates to the suppression of the growth of dendrites.

Surface Modification of Lithium Metal Electrode, KR100449765B1

The document relates to a lithium metal anode comprised of an integrated separator layer, a current collector layer, and a protective film layer. The separator layer may be composed of porous polyethylene, polypropylene, or multilayer structures thereof. The protective film layer between the separator and the lithium metal layer has high lithium-ion conductivity due to low electrolyte permeability. The protective film may include both organic and inorganic materials.

The document relates to a lithium metal electrode with an integrated separator layer and protective layer. However, the creation of the protective layer does not involve any post-processing for enhancing the material properties of raw materials.

Anode for Lithium Metal Battery Comprising Ti2C Thin-Film, Preparation Method Thereof and Lithium Metal Battery Comprising the Same, KR 20190102489A

The document suggests the formation of a Ti₂C thin-film on a lithium metal anode to form a stable SEI and inhibit the formation of lithium dendrites. The Ti₂C thin-film induces rapid but stable diffusion of lithium ions, preventing the formation of lithium dendrites. It also increases the stability of SEI by preventing undesired galvanometric reactions between lithium metal and an electrolyte. In addition, the document relates to a method of creating a Ti₂C thin-film on a substrate using a solution with dispersed Ti₂C powder, the Langmuir-Blodgett scooping (LBs) method, and a method of transferring created Ti₂C thin-film onto the lithium metal anode surface.

Although the document suggests an effective way of suppressing the growth of dendrites, the formation of Ti₂C thin-film and its transfer to a lithium metal anode involves time and cost-inefficient processes to etch the lithium metal anode.

Coated Lithium Electrodes, U.S. Pat. No. 6,955,866B2

The document relates to an electrochemical battery using a lithium metal anode, where the anode is a ternary alloy layer comprised of lithium and two other metals. In particular, the first metal other than lithium provides a matrix to accommodate volume change involved in lithium cycling, while the second metal is alloyed with lithium and the first metal. The first metal can be copper, and the second metal can be tin. Lithium metal anodes coated with a ternary alloy layer showed improved anode stability and lithium cycling efficiency.

However, the method includes alloying lithium with other metals, necessarily.

Processing of Interface for Stabilized Lithium Anode, U.S. Ser. No. 10/256,448B2

The document relates to an electrochemical battery using a lithium metal anode comprised of an interfacial layer that controls the reactivity of lithium metal towards an electrolyte and accommodates a significant volume change in lithiation cycles. The interfacial layer allows lithium ions to pass through its wall. It also creates a stable solid electrolyte interphase (SEI) layer on one side of the interfacial layer, isolating the deposition and dissolution of lithium metal on the other side. The interfacial layer is loosely attached to the lithium metal anode, leaving space between the interfacial layer and the lithium metal anode to accommodate the volume change of the lithium metal anode.

The interfacial layer includes two-dimensional atomic crystal layered materials consisting of graphene and h-BN (hexagonal boron nitride). They are chemically inert to electrolytes and lithium metal and are mechanically sturdy. In addition, they have a small pore size, are ultrathin, and are flexible; however, h-BN cannot be used directly without graphene because of its insulating nature.

The document suggests a method of efficiently controlling both the mechanical and chemical aspects of lithium metal reactivity. However, forming an interfacial layer of graphene and h-BN requires a high temperature (1000° C.) and a controlled environment, making it an expensive process.

Lithium Metal Anode for Lithium Metal Polymer Secondary Battery Comprising Spacer and Method for Forming the Same, KR100582558B1

The document relates to a lithium metal anode divided by grid-shaped spacers. The spacers are laminated onto a current collector and are thicker than a lithium metal film. An opening between the spacers could have a polygonal, circular, or elliptical shape, and the spacers were made mainly of glass-reinforced fibers, carbon fibers, or aluminum oxides.

Separated lithium metal films increase their volume during a lithiation cycle within the gaps between the spacers. Thus, the volume change of the lithium metal anode occurs without volume change in an actual cell, maintaining SEI and increasing the stability of a lithium metal battery.

In the previous methods, various approaches to inhibiting the formation of dendrites and increasing the stability of lithium metal anodes in lithium rechargeable batteries are suggested. However, these methods have been successful to a certain degree in increasing the stability of batteries but are not cost-effective solutions in a large-scale manufacturing process.

### PRIOR ART DOCUMENTS

### Patent Document

(Document 001) U.S. Pat. No. 10,483,534 B2
(Document 002) CN 111490252 A
(Document 003) DE 102013114233 A1
(Document 004) KR 10-0449765 B1
(Document 005) KR 2019-0102489 A
(Document 006) U.S. Pat. No. 6,955,866 B2
(Document 007) U.S. Pat. No. 10,256,448 B2
(Document 008) KR 10-0582558 B1

### Non-Patent Documents

(Document 001) Y. Guo, H. Li, and T. Zhai, Adv. Mater., 2017, 29, 1700007.
(Document 002) L, Li, S. Li, and Y. Lu, Chemical Communication, 2018, 54, 6648-6661.
(Document 003) C. Monroe and J. Newman, J. Electrochem. Soc., 2003, 150, A1377
(Document 004) Y. Lu, K. Korf, Y Kambe, Z. Tu and L. A. Archer, Angew. Chem., Int. Ed. Engl., 2014, 53, 488-492.
(Document 005) N. Chazalviel, 1990, Physical Review A: Atomic, Molecular, and Optical Physics and Quantum Information, 42, 7355-7367.
(Document 006) C. Monroe and J. Newman, J. Electrochem. Soc., 2005, 152, A396-A404
(Document 007) C. P. Yang, Y. X. Yin, S. F. Zhang, N. W. Li, and Y. G. Guo, Nat. Commun., 2015, 6, 8058
(Document 008) A. A. Assegie, J. H. Cheng, L. M. Kuo, W. N. Su and B. J. Hwang, Nanoscale, 2018, 10, 6125-6138.
(Document 009) S. Choudhury, Z. Tu, S. Stalin, D. Vu, K. Fawole, D. Gunceler, R. Sundararaman, and L. A. Archer, AngewandteChemie International Edition, 2017, 56, 13070-13077.
(Document 010) J. Xiang, Z. Cheng, Y. Zhao, B. Zhang, L. Yuan, Y. Shen, Z. Guo, Y. Zhang, J. Jiang and Y. Huang, Adv. Sci., 2019, 6, 1901120.
(Document 011) H. Zhang, X. Liao, Y. Guan, Y. Xiang, M. Li, W. Zhang, X. Zhu, H. Ming, L. Lu, J. Qiu, Y. Huang, G. Cao, Y. Yang, L. Mai, Y. Zhao, H. Zhang, Nature Communications, 2018, DOI: 10.1038/s41467-018-06126-z.
(Document 012) L. Liu, Y. X. Yin, J. Y. Li, N. W. Li, X. X. Zeng, H. Ye, Y. G. Guo, L. J. Wah, Joule, 2017, 1, 563-575. DOI: 10.1016/j.joule.2017.06.004.
(Document 013) K. Chen, R. Pathank, A. Gurung, K. M. Reza, N. Ghimire, J. Pokharel, A. Baniya, W. He, J. J. Wu, Q. Qiao, Y. Zhou, 2020, Journal of Materials Chemistry A, 8, 1911-1919.
(Document 014) J. Yu, Y. Dang, M. Bai, J. Peng, D. Zheng, J. Zhao, L. Li, Z. Fang, 2019, Front. Chem., DOI: 10.3389/fchem.2019.00748.
(Document 015) T. Wang, R. V. Salvatierra, A. S. Jalilov, J. Tian, J. M. Tour, 2017, ACS Nano, 11, 10761-10767. DOI: 10.1021/acsnano.7b05874.

### DISCLOSURE

### Technical Solution

The present disclosure presents a method of manufacturing an electrode different from conventional manufacturing methods. In the presented method, a three-dimensional nanoporous structure is generated based on irradiation of photoelectromagnetic energy, thereby making it possible to prevent the growth of lithium dendrites, enhance the stability of a lithium metal anode, and ensure energy efficiency and applicability to a current manufacturing process.

The present disclosure presents a method that helps suppress the growth of lithium dendrites and enhance the stability of a lithium metal anode in lithium rechargeable batteries. In the method, photoelectromagnetic energy is applied to generate a three-dimensional structure within a short period. A three-dimensional porous structure on a lithium metal anode provides space for accommodating volume change in the lithium metal anode. The three-dimensional porous structure is associated with lithium plating and uniformly distributed to prevent the growth of lithium dendrites and maintain a stable SEI.

The present disclosure presents a conductive nanoporous coating of nanocomposite materials applied to the surface of a lithium metal anode. The conductive nanoporous nanocomposite materials are generated by irradiating photoelectromagnetic energy such as intense pulsed light (IPL) to an applied mixture including a polymer matrix, a conductive additive, and an evaporation additive having a low melting point.

The present disclosure presents a three-dimensional structure of carbon nanotubes applied on the surface of a lithium metal anode. The three-dimensional framework of carbon nanotubes is generated by irradiating photoelectromagnetic energy such as IPL to a mixture of randomly dispersed high aspect ratio carbon nanotubes and a metal oxide solution.

The present disclosure presents a three-dimensional structure of a lithium metal anode, integrated with a current collector based on the three-dimensional form of copper, silver, and carbon nanotubes. The three-dimensional structure of a lithium metal anode is generated by electroplating lithium onto the current collector. The surface of the current collector is pre-treated with a three-dimensional structure of copper, sinter, and carbon nanotubes obtained by sintering it as a result of the irradiation of photoelectromagnetic energy such as IPL.

The present disclosure presents a cooling system to transfer residual heat away from lithium metal accumulated during the irradiation of photoelectromagnetic energy.

Furthermore, the present disclosure presents the surface treatment of a lithium metal anode using sandblasting to increase the adhesion of protective coating material and reduce contact resistance.

A lithium metal battery's anode electrode in one embodiment comprises of a current collector; a lithium metal layer disposed on the current collector; a protective coating disposed on the lithium metal layer and having a three-dimensional open-cell porous structure; a lithium alloying metal coating being disposed on a surface of the protective coating.

The lithium metal layer may have an engineered surface texture.

The protective coating may be a polymeric nanocomposite layer comprising an open-cell nanoporous polymer matrix, conductive carbon additives, and structural support materials.

The protective coating may comprise a mattress of carbon nanofibers having a three-dimensional open-cell porous structure.

The protective coating may comprise a network of carbon nanotubes with a three-dimensional open-cell porous structure comprising lithiophilic metal oxides.

A top layer of the network of carbon nanotubes may be lithiophobic carbon nanotubes, and a bottom layer may be lithiophilic metal oxide-carbon nanotube composites.

The lithiophilic metal oxides may comprise zinc oxide, iron oxide, manganese oxide, and titanium oxide.

The lithium alloying metal may be selected from indium, tin, bismuth, gallium, silver, gold, zinc, aluminum, platinum, germanium, and Field's metal.

An anode electrode for a lithium metal battery in another embodiment comprises a metal current collector; and a three-dimensional network structure coated on the metal current collector, where the three-dimensional network structure is based on metal or carbon.

The anode electrode may further comprise a lithium metal layer formed on the surface of the three-dimensional network structure.

A method of manufacturing an anode electrode for a lithium metal battery in one embodiment comprises disposing of a lithium metal layer on a current collector; forming a protective coating having a three-dimensional open-cell porous structure on the lithium metal layer; and forming a lithium alloying metal coating on the surface of the protective coating, where at least one of the steps of forming a protective coating and forming a lithium alloying metal coating comprises irradiating photoelectromagnetic energy.

Forming a protective coating consists of generating a slurry with a first polymer, a second polymer having a lower boiling point than the first polymer, a conductive carbon additive, a mixture of structural support additive, and a solvent. The slurry is coated on the lithium metal layer and dried to form an intermediate coating. The protective coating is formed using thin-film coating, irradiating photoelectromagnetic energy to the intermediate coating, and vaporizing the second polymer in the intermediate coating to form nanopores.

The first polymer and the second polymer may be selected from polyacrylonitrile (PAN), Polytetrafluoroethylene (PTFE), poly(methyl methacrylate) (PMMA), poly(3,4-ethylene dioxythiophene) polystyrene sulfonate (PEDOT: PSS), Polydiacetylenes (PDAs), polypropylene, polystyrene (PS), polyurethane (PU), polyethylene oxide (PEO), polyethylene terephthalate (PET), Styrene-ethylene-butylene-styrene (SEBS), glycerol, sucrose, cellulose, and lignin. The conductive carbon additive may be selected from single-walled carbon nanotubes (SWCNTs), multi-walled carbon nanotubes (MWCNT), graphene, graphene oxides, graphene nanoplatelets (GNP), and carbon dots. The structural support additive may be selected from hexagonal boron nitride (hBN), silicon nanowires (SiNW), and aluminum oxides.

Forming a protective coating may comprise of preparing a nanofiber precursor solution, electrospinning the nanofiber precursor solution to a mattress of polymer nanocomposite nanofibers, applying photoelectromagnetic energy to carbonize the polymer nanocomposite nanofibers and form a mattress of carbon nanofibers, and attaching the mattress of carbon nanofibers to lithium metal anodes.

The nanofiber precursor solution may comprise polymers, conductive carbon additives, and solvents. The polymer may comprise of polyamides (PA), polyacrylamide (PAAm), polyurethane (PU), polybenzimidazole (PBI), polycarbonate (PC), polyethylene (PE), polyacrylonitrile (PAN), poly(methyl methacrylate) (PMMA), Polydiacetylenes (PDAs), polypropylene (PP), polystyrene (PS), polyethylene oxide (PEO), polyethylene naphthalate (PEN), polyethylene terephthalate (PET), polyvinylchloride (PVC), polyvinyl pyrrolidone (PVP), collagen, and cellulose acetate (CA). The conductive carbon additive may comprise of single-walled carbon nanotubes (SWCNT), multi-walled carbon nanotubes (MWCNT), graphene, graphene oxides, graphene nanoplatelets (GNP), and carbon dots. The solvent may comprise water, acetone, formic acid, chloroform, isopropanol, N-Methyl-2-pyrrolidone (NMP), Dimethylformamide (DMF), dimethyl sulfoxide (DMSO), and tetrahydrofuran (THF).

The step of attaching a mattress of carbon nanofibers may comprise applying heat and compressive stress together to adhere the mattress of carbon nanofibers to the lithium metal layer, and the heat and compressive stress may be applied via calendering machine, compression molding machine, or hot press.

The step of forming a protective coating may comprise mixing a nanocomposite precursor of lithiophilic metal oxides and lithiophobic carbon nanotube, depositing the nanocomposite of lithiophilic metal oxides and lithiophobic carbon nanotubes on a lithium metal layer, using thin-film coating, and applying photoelectromagnetic energy to form a network of carbon nanotubes with gradient lithiophilic-lithiophobic properties, where a top layer of the network of carbon nanotubes is a lithiophobic carbon nanotube and a bottom layer is a lithiophilic metal oxide-carbon nanotube composite.

The step of forming a lithium alloying metal coating may comprise disposing powdered lithium alloying metal on the protective coating. This allows the powdered lithium alloying metal to come into the protective coating by using a calendering process, irradiating photoelectromagnetic energy to melt the powdered lithium alloying metal, and coating the melted lithium alloying metal on a surface of the protective coating based on capillary action.

The method may further comprise forming an engineered surface texture on the lithium metal layer through sandblasting.

A method of manufacturing an anode electrode for a lithium metal battery in another embodiment comprises forming a slurry of one or more metallic nanoparticle precursors, a conductive carbon additive, a mixture of a polymeric carrier and a solvent, depositing the slurry on a metal current collector using thin-film coating; and irradiating photoelectromagnetic energy to sinter the deposited slurry, and sintering the slurry as a result of the irradiation of photoelectromagnetic energy to form a three-dimensional metal-based network structure.

The metallic nanoparticle precursor may comprise copper-based nanoparticle precursors; the copper-based nanoparticle precursor may comprise of one or more selected from copper, copper acetate, copper oxide, and copper formate tetrahydrate.

The method may further comprise electroplating a metal current collector with the three-dimensional metal-based network structure with lithium.

A method of manufacturing an anode electrode for a lithium metal battery in yet another embodiment may comprise mixing a carbon precursor, a conductive carbon additive, and a solvent to generate a slurry; and depositing the slurry on a metal current collector using thin-film coating; and applying photoelectromagnetic energy to the deposited slurry to carbonize the slurry and form a three-dimensional carbon-based network structure.

The carbon precursors may be selected from asphaltene, mesophase pitch, cellulose, cellulose nanocrystals, and lignin.

The method may further comprise electroplating a metal current collector with the three-dimensional carbon-based network structure with lithium.

### DESCRIPTION OF DRAWINGS

Based on the accompanying drawings, several aspects according to the present disclosure are described by way of examples, and not by way of limitations, in detail, wherein:

FIG. 1 is a schematic view showing a lithium metal layer surface texture engineered via sandblasting and the formation of a protective coating.

FIGS. 2a and 2b are schematic views showing a method of forming a polymeric nanoporous nanocomposite coating on a lithium metal layer. FIG. 2a shows lithium foil coated with a slurry and FIG. 2b shows a polymeric nanoporous nanocomposite coating formed on a lithium metal layer by applying photoelectromagnetic energy.

FIGS. 3a and 3b are schematic views showing a method of generating a three-dimensional structure of carbon nanotubes on a lithium metal layer. FIG. 3a shows a coating including carbon nanotubes and metal oxides formed on a lithium metal layer. FIG. 3b shows a complex three-dimensional network of carbon nanotubes and metal oxides generated via irradiation of photoelectromagnetic energy.

FIG. 4 is a schematic view showing a cooling system for lithium metal foil or a metal current collector.

FIGS. 5a and 5b are schematic views showing a method of generating a three-dimensional structure of copper-silver-carbon on a current collector.

FIG. 6 is a schematic view showing an example of a method for coating a lithium metal layer with lithium alloying metal to improve lithium-ion affinity and stabilize an SEI.

FIG. 7 is a schematic view showing an example of a method of coating a three-dimensional structure with lithium alloying metal to improve lithium-ion affinity and stabilize an SEI.

FIGS. 8a and 8b are schematic views showing the porosity of porous nanocomposite film samples that are (a) 70 μm thick and (b) 100 μm thick in scanning electron microscope (SEM) images.

FIG. 9 is a schematic view showing the porosity of a porous nanocomposite film sample based on gas pycnometer analysis.

FIG. 10 is a schematic view showing the symmetric battery structure to analyze the stability of a lithium metal anode of a porous nanocomposite film sample.

FIGS. 11a and 11b are schematic views showing analysis results of the stability of the lithium metal anodes of porous nanocomposite film samples with different thicknesses (70 μm and 100 μm).

FIGS. 12a and 12b are schematic views showing results comparing surface morphology of a copper-based metal conductive ink before and after the irradiation of photoelectromagnetic energy.

### MODE FOR INVENTION

The present disclosure presents a novel method focused on photoelectromagnetic energy irradiation of intense pulsed light (IPL) and the like to form a three-dimensional structure as a means of suppressing the growth of lithium dendrites. Materials can be deposited on a substrate, using a tape casting method and the like, and irradiated with photoelectromagnetic energy, making these procedures suitable for current large-scale battery manufacturing processes using a roll-to-roll process. The suggested process in the present disclosure has advantages over the other processes set forth hereafter since the process is short and ensures high energy efficiency. The irradiated photoelectromagnetic energy is absorbed by a coated layer of the materials to form the three-dimensional structure. Additionally, a short duration of photoelectromagnetic energy irradiation prevents a transfer of residual heat from the coated layer to the lithium metal, avoiding direct heating of the lithium metal substrate, which may degrade performance. Further, the present disclosure suggests a new cooling device to prevent thermal degradation of lithium metal.

With an increasing demand for lithium rechargeable batteries with higher energy density, new materials replaceable with a conventional graphite anode attract attention. Among various candidates, lithium metal anodes were considered promising due to its high theoretical capacity (3,860 mAh/g), low electrochemical potential (−3.04 V), and low density (0.534 g/cm³) [Guo et al. 2017].

However, the scientific community discovered that the commercialization of lithium metal batteries has intrinsic problems that directly threaten the safety of batteries [Whittingham 2004]. Lithium metal quickly develops lithium dendrites during repeated charging and discharging cycles. Lithium dendrites often break off and form irreversible lithium debris within electrolytes, causing degradation in the capacity of batteries. In worse cases, lithium dendrites grow sharp and penetrate a separator, causing a short circuit leading to fires and occasional explosions.

Additionally, the low electrochemical potential of lithium metal is a double-edged sword: it provides a higher voltage to a battery but also causes it to easily react with any organic electrolyte and even the products shuttled from cathode materials (e.g., polysulfides in the case of a lithium-sulfur battery). These reactions are irreversible and increase the degrading rate of lithium metal batteries by increasing cell impedance and decreasing total capacity [Li et al. 2019]. In addition to the aforementioned problems, a large volume change of lithium metal during a lithiation cycle, the consumption of electrolytes, and unstable solid electrolyte interphase (SEI) layer cause degradation of lithium metal anodes.

To address the challenges associated with lithium metal anodes, the application of a protective coating is suggested. In the present disclosure, three different protective coatings for lithium metal anodes are described, and one protective coating for a current collector. The protective coatings have three-dimensional open-cell-nanoporous structures but are composed of different materials. However, the manufacturing processes are similar where the utilized processes are easily applicable in roll-to-roll manufacturing processes, involving photoelectromagnetic energy application techniques. Hereinafter, embodiments of preparing lithium metal anode protective coatings are described in detail.

Sandblasting of Lithium Metal Anode

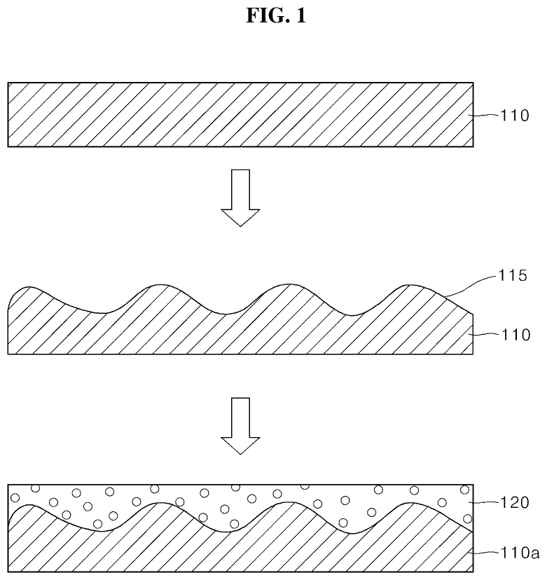

It is beneficial to prepare a lithium metal anode surface with an engineered surface texture before protective coatings are applied to the lithium metal anode. There are different methods to creating an engineered surface texture on a lithium metal surface, including processes such as sanding, machining, micro-needling, using a femtosecond laser, or sandblasting. A microstructure formed by these processes increases a contact surface area, thereby increasing adhesion to the coated material, reducing contacting resistance, and increasing an ionic diffusion rate (See FIG. 1).

FIG. 1 schematically shows a sandblasting process for forming an engineered surface texture 115 on a lithium metal layer 110 applied to an anode electrode of a lithium metal battery. In the present disclosure, the lithium metal layer is often referred to as a lithium metal anode. Additionally, FIG. 1 schematically shows an example of a protective coating 120 formed on a lithium metal layer 110a having an engineered surface texture.

Sandblasting utilizes a stream of abrasive particles colliding with a target surface to induce abrasion and surface deformation. The shape, size, hardness, speed, and contact angle of the abrasives determine the effectiveness of the sandblasting method. The final speed of the abrasives is controlled by the amount of pressure applied from a pump, the type of nozzle, and the distance from the target surface.

The abrasive particles may include but are not limited to aluminum oxide, ground silica, and chemically inert soda-lime glass beads. The abrasive particles may have an average diameter ranging from 500 nm to 10 μm. In this embodiment, abrasive particles in a spherical shape are utilized and carrier gas applied must be an inert gas instead of typically used compressed air to minimize a chemical reaction between lithium metal and moisture.

In this exemplary embodiment, sandblasting is utilized to create a lithium metal surface having a mean surface roughness Ra ranging from 1 to 100 on. A range of different process parameters can be used to achieve a target mean surface roughness Ra. In one example, 80 psi of compressed argon was supplied to shoot aluminum oxide particles having an average diameter of 50 μm at a contact angle of 15°. The sandblasting area had a diameter of 2 cm, and the surface was sandblasted at a rate of 1 cm/s in two repeated cycles. The sandblasting process was performed within a glovebox filled with argon, where humidity was at 0.1 ppm. A contact profilometer (Mitutoyo SJ.201P) was used to measure 10 different points on the surface to find an average value of the mean surface roughness R a of the lithium metal anode. The measured mean surface roughness R a was 67.4 on.

The sandblasting process involves creating a rough surface, i.e., an engineered surface texture 115, on the lithium metal anode 110, thereby increasing a contact surface, improving adhesion of a conductive protective coating 120, and reducing interfacial resistance.

Protective Coating with Three-Dimensional Open-Foam Porous Structure

Protective coatings with a three-dimensional open-foam porous structure have been developed for several purposes. First, its complex structure provides abundant nucleation points where lithium can be electroplated evenly instead of the concentrated growth of lithium dendrites at a few nucleation points. Secondly, the three-dimensional structure has a much larger surface area than a planar surface, which reduces local current density in the lithium metal anode, thus mitigating the growth of dendrites [Monroe and Newman 2005]. Furthermore, submicron range structures induce a homogeneous charge distribution, leading to a reduction in dendrite growth [Yang et al. 2015].

The low density of the three-dimensional open-foam porous structure also assists in mitigating stress that is induced by lithium metal's volume expansion. Instead of increasing the volume of the lithium metal anode, lithium electroplating occurs within the three-dimensional structure protective coating. Any deformation, regardless of whether it is induced internally by volume change or induced externally, may cause the three-dimensional structure to mechanically absorb the deformation without causing additional stress.

This embodiment describes three different protective coatings with a three-dimensional open-foam porous structure. This includes a nanoporous polymeric nanocomposite coating, a carbon-nanotube network with a metal oxide coating, and a mattress of carbon fibers.

Nanoporous Polymeric Nanocomposite Coating

Polymer materials are a promising candidate for lithium metal anodes' protective coatings due to the material characteristics and easiness of handling. Polymeric materials are used commonly in various parts of lithium-ion batteries, from a separator, a binder for electrodes, and as polymeric gel electrolytes in lithium solid-state batteries. Polymers can have different characteristics depending on their components, structures, and functional groups.

Polymers used for the coating of lithium metal anodes exhibit electrochemical stability against both lithium metals and electrolytes, homogenize a lithium-ion flux near an electrode surface, hinder the formation of lithium dendrites, and reduce direct contact between the lithium metals and the electrolytes while maintaining consistent contact with the electrode under large volume changes. Furthermore, polymers can be easily coated on lithium metal anodes using conventional methods, such as spin coating, spray coating, film coating, or a doctor blading method. The easiness of a coating method ensures efficiency in large-scale processing, easily controlling the thickness of a coating layer.

Examples of polymeric materials used for the coating of lithium metal anodes may include one or more polyethylene oxide (PEO), polyether sulfone (PES), poly(dimethylsiloxane) (PDMS), poly(ethylene-vinyl alcohol-β-acrylonitrile ether) (EBC), polyvinyl alcohol (PVA), and polydopamine (PDA). The abovementioned polymers display strong electrostatic interactions with lithium ions because of the polar sides of these materials (e.g., oxygen groups in PEO, cyano groups in EBC, and hydroxyl groups in PVA).

Even without a three-dimensional structure, a poly(dimethylsiloxane) (PDMS) thin-film [Zhu et al. 2017] and other types of highly viscous polymers have been utilized to stabilize lithium metal anodes during a lithiation cycle. Moreover, a polyethylene oxide (PEO) coating showed the formation of a stable polar oligomer during the first electrochemical cycle of lithium metal anodes, resulting in a stabilized SEI layer [Assegie et al. 2018].

Another interesting example of a polymeric coating on lithium metal anodes is the utilization of polyvinylidene fluoride (PVDF) in a β-phase. PVDF in the β-phase has a ferroelectric property due to its unique crystalline structure by introducing a piezoelectric potential across the coating under stress (i.e., stress from a volume expansion of lithium metal anodes). The piezoelectric potential functions as a pump for lithium-ions, accelerating the diffusion of lithium-ions across the coating to increase charging speed and homogenization of a lithium-ion flux [Xiang et al. 2019].

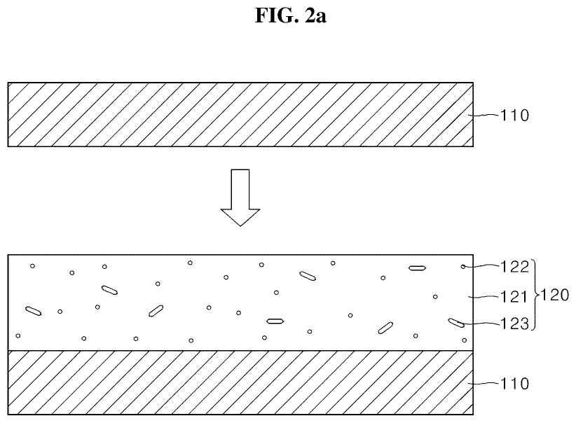

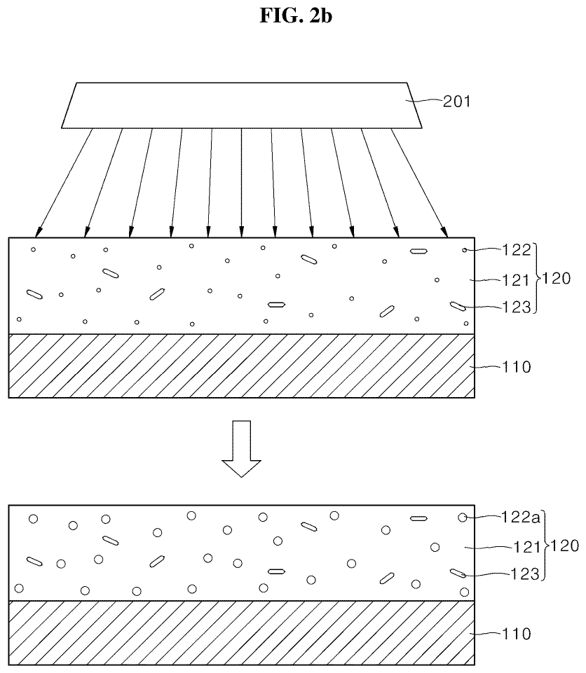

FIGS. 2a and 2b schematically illustrate a method of forming a polymeric nanoporous nanocomposite coating on a lithium metal layer. FIG. 2a shows lithium foil coated with a slurry and FIG. 2b shows a polymeric nanoporous nanocomposite coating that is formed on a lithium metal layer by applying photoelectromagnetic energy.

In the embodiment, the lithium metal layer 110 applied to an anode electrode of a lithium metal battery may be lithium foil. The lithium metal layer 110 is disposed on a metal current collector such as a copper current collector. The slurry mixture comprises a high-boiling point first polymer 121, a low-boiling point second polymer 122 having a boiling point lower than the first polymer 121, and a conductive carbon additive 123. The slurry is deposited on the lithium metal layer 110 and dried in a vacuum oven to form a coating 120 (see FIG. 2a).

In addition, photoelectromagnetic energy is applied through IPL irradiation equipment 201 to heat the coating 120 and vaporize the low-boiling point second polymer 121, for example. The process eventually leaves nanopores 122a in the polymeric nanocomposite, thus an open-cell porous structure in a continuous pore form may be formed through the nanopores 122a (see FIG. 2b).

In this embodiment, proposed is a new manufacturing method to fabricate a nanocomposite coating having an open-cell porous structure on the lithium metal layer 110. In the method, rapid evaporation of a low boiling-point material within the protective coating 120 is utilized to create the open-cell porous structure. The nanocomposite coating consists of the main polymer matrix, conductive carbon additives, structural support additives, and a second polymer material having a significantly low boiling point compared to the main polymer.

The main polymer (the first polymer) matrix provides the main body of a porous film structure. The second polymer having a significantly low boiling point creates pores as it escapes from the film during the rapid evaporation process, induced by applied photoelectromagnetic energy. Some examples of polymers used as the first and second polymers include polyacrylonitrile (PAN), Polytetrafluoroethylene (PTFE), poly(methyl methacrylate) (PMMA), poly(3,4-ethylene dioxythiophene) polystyrene sulfonate (PEDOT: PSS), Polydiacetylenes (PDAs), polypropylene, polystyrene (PS), polyurethane (PU), polyethylene oxide (PEO), polyethylene terephthalate (PET), styrene-ethylene-butylene-styrene (SEBS), glycerol, sucrose, cellulose, or lignin. Among them, two or more polymers having a difference of 10° C. or higher or 20° C. or higher in their boiling points may be selected as the main polymer and the second polymer.

The carbon-based conductive nanomaterials form a conductive network within the polymer matrix and act as an absorber for photoelectromagnetic energy. Examples of carbon-based conductive nanomaterials include single-walled carbon nanotubes (SWCNT), multi-walled carbon nanotubes (MWCNT), graphene, graphene oxides, graphene nanoplatelets (GNP), or carbon dots.

The additives for structural support are materials having high mechanical strength and electrochemical inertness. The additives enhance the mechanical strength and durability of porous polymer nanocomposites. Some examples of additives for structural support include hexagonal boron nitride (hBN), silicon nanowires (SiNW), and aluminum oxides.

The aforementioned components are mixed with appropriate solvents for the polymers used in the mixture to form a slurry and are coated on the surface of the lithium metal anode to form a film using a thin-film coating technique such as doctor blading, bar coating, spray coating, or solution casting. The film will then dry within a vacuum oven. The dried film would be irradiated with photoelectromagnetic energy for the rapid evaporation of the low boiling-point second polymer, creating an open-cell porous structure as the evaporating gas escape from the film.

CNT Network with Metal Oxide

Carbon conductive materials are used for various applications due to their high electrical conductivity and mechanical strength. Among various carbon conductive materials, carbon nanotubes (CNTs) are especially known for their high aspect ratio through their nanometric diameter and micrometric length. With the high aspect ratio, high electrical conductivity, and lithiophobic material property, a three-dimensional structure of CNTs could form an ideal interfacial layer on lithium metal anodes to prevent the formation of lithium dendrites and form a stable SEI layer while facilitating the diffusion of lithium ions.

However, the lithiophobic property of CNTs poses a challenge in adhering the CNT-based structure to the lithium metal anodes. Zhang and others [Zhang et al. 2018] reported a lithium metal anode with an interfacial layer having gradient lithiophilic-lithiophobic properties. CNTs with various zinc oxides (ZnO) were dropped on a lithium foil layer by layer to form a bottom layer of lithiophilic property and a top layer of lithiophobic property. The gradient lithiophilic-lithiophobic layer coated on the lithium metal foil was compared with lithium metal foil coated with just CNTs. Compared to the lithium metal foil coated only with CNTs, the gradient lithiophilic-lithiophobic layer showed superior cycling stability from symmetric cell tests performed at a constant current density of 1 mA·cm⁻². In the symmetric cell test, sample lithium foil is placed within a coin cell as both the anode and cathode. It then undergoes charging and discharging cycles under constant current density. The amplitude of charging and discharging voltages should remain constant. If an increase in the amplitude of the voltage is observed, the formation of lithium dendrites has initiated within a cell. The gradient lithiophilic-lithiophobic layer showed stability for up to 500 hours of cycling time while the sample coated with just CNTs showed unstable behaviour of increasing the amplitude of voltage after 200 hours of cycling time.

The idea of gradient lithiophilic-lithiophobic interfacial layer is a promising method for suppressing the growth of lithium dendrites in lithium metal batteries. However, the method suggested by Zhang and others entails a complicated manufacturing process. For example, to create the gradient layer, solutions with different concentrations of CNTs and zinc oxide have to be prepared. They are deposited on the lithium foil layer by layer, which means it enters a drying process between depositions of each layer, therefore, increasing manufacturing time. The solvent can not rapidly dry at high temperatures because of the lithium metal's low melting point (180° C.).

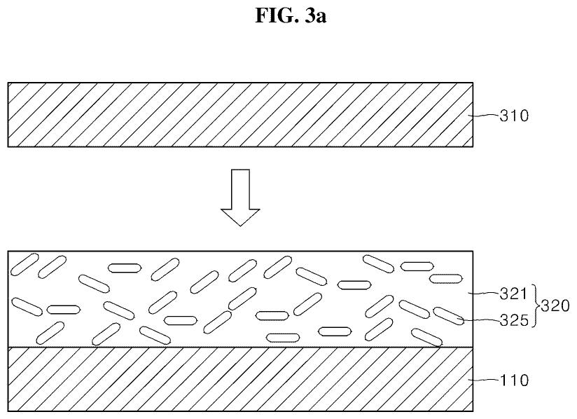

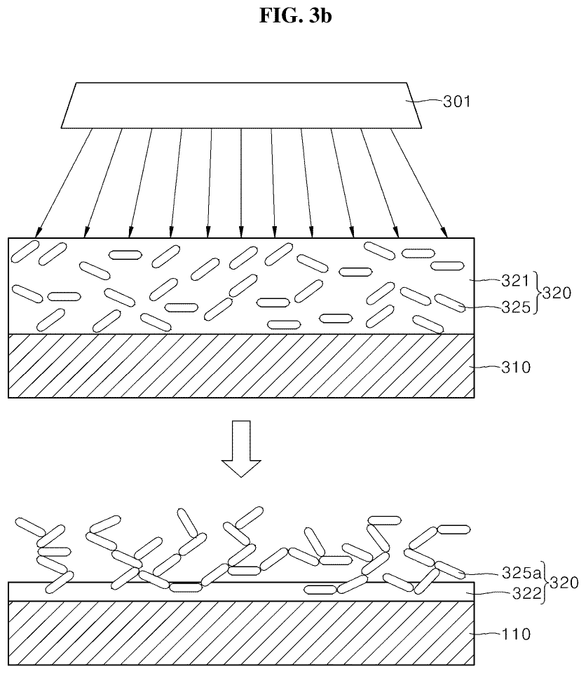

FIG. 3 schematically shows a method of generating a three-dimensional structure of carbon nanotubes on a lithium metal layer.

In the embodiment, the lithium metal layer 310 may be lithium foil. A slurry including a solvent 321, randomly dispersed carbon nanotubes 325, and metal oxide is deposited on the surface of the lithium metal layer and dried in a vacuum oven to form a coating 320 (see FIG. 3a).

The irradiation of photoelectromagnetic energy via IPL heats the coating 320, vaporizes the solvent 321, and leaves a complex three-dimensional network of mutually connected carbon nanotubes 325a and metal oxide 322 (see FIG. 3b).

In the present disclosure, a new method utilizing photoelectromagnetic energy is suggested. The gradient of a lithiophilic and lithiophobic layer is created via the effect of photoelectromagnetic energy rather than by depositing them layer by layer. Instead of multiple solutions with different concentrations of CNTs and zinc oxide, one slurry mixture of CNTs, metal oxide, a small number of polymeric binders, and a solvent is deposited on the lithium metal foil and irradiated with the photoelectromagnetic energy. The photoelectromagnetic energy evaporates polymeric coatings and reduces metal oxide in the top layer, leaving a lithiophobic CNT layer at the top. Since the irradiated photoelectromagnetic energy is applied from the top, less energy is transferred to the depth of coated slurry, leaving lithiophilic metal oxides and polymer binders in the bottom layer.

The lithiophilic metal oxides may include but are not limited to one or more zinc oxide, iron oxide, manganese oxide, and titanium oxide. The carbon nanotubes may include but are not limited to single-walled CNTs (SWCNTs), double-walled CNTs (DWCNTs), multi-walled CNTs (MWCNTs), functionalized CNTs, or short carbon nanofibers. The solvents may include but are not limited to, water, ethanol, hexane, N-Methyl-2-pyrrolidone (NMP), Dimethylformamide (DMF), dimethyl sulfoxide (DMSO), or a combination thereof.

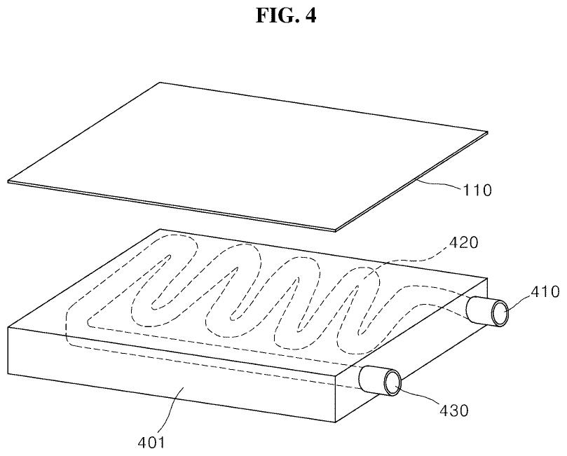

FIG. 4 schematically shows a cooling system for lithium metal foil or a metal current collector.

The cooling system illustrated in FIG. 4 shows the transfer of residual heat away from the lithium metal layer 110 or the metal current collector that could accumulate during the irradiation of photoelectromagnetic energy in FIGS. 2b and 3b.

The cooling system includes a holder plate 401 with a thermally conductive metal, a coolant inlet 410 disposed at one side of the holder plate, a heat exchange flow path 420 extended from the coolant inlet into the holder plate, and a coolant outlet 430 disposed at one side or the other side of the holder plate and connected to the heat exchange flow path 420.

The holder plate 401 may include a metal plate with extruded fixtures to fit a lithium metal anode of a designated size, the metal plate is thick enough to hold the heat exchanger system, and material for the metal plate may include, but are not limited to, copper and aluminum.

The coolant inlet 410 and outlet 430 may connect to a coolant pump and the like. Alternatively, a Peltier element may be replaced with the heat exchange flow path through which coolants flow.

Coolants such as cooling water pass through the heat exchange flow path 420 of a material having high thermal conductivity. For example, aluminum in contact with a lithium metal anode can take away any extra heat absorbed into the lithium metal anode via the irradiation of photoelectromagnetic energy.

Carbon Nanofiber/Fiber Mattress

The mattress of carbon fibers is another porous carbon structure applicable to lithium metal anodes to suppress the formation of lithium dendrites and provide space for the deposition of lithium during the charging process. The fabrication of carbon fibers is a relatively well-established process. However, it often requires a long process time and high-temperature heat to stabilize and carbonize a carbon precursor material. After the high-temperature process, the mattress of carbon fibers can be manufactured separately and adhere to the lithium metal anode. The temperature and pressure required for allowing the mattress of carbon fibers to adhere to lithium metal are usually kept below a melting point (180.5° C.) of lithium metal.

In 2017, Liu and others created a free-standing hollow carbon fiber structure on lithium metal anodes by carbonizing commercial cotton. They observed that the deposition of lithium occurred on the outer surface of the carbon fiber, filling a gap between multiple carbon fibers, as well as the inner surface of the carbon fiber, filling a hollow space within the carbon fibers. By maximizing the increased surface area and porous structure, the lithium metal anode coated with the hollow carbon fiber structure showed stability for more than 600 cycles under the symmetric cell test, whereas bare lithium foil became unstable after 180 cycles under the same conditions [Liu et al. 2017]. Another study performed by Zhang and others involved coating carbon fibers with a layer of lithiophilic silver by electroplating silver directly on the carbon fibers. This made the infusion of lithium easier and led to the acquisition of lithium metal anodes having similar stability to pure lithium metal [Zhang et al. 2017].

In the present disclosure, proposed is a new method of creating a three-dimensional carbon fiber structure on lithium metal anodes to suppress the growth of dendrites and maintain stability. The method utilizes the irradiation of photoelectromagnetic energy for a carbonization process, increasing energy efficiency and decreasing processing time. To compensate for the low energy penetration depth, an electrospinning process creating polymeric nanocomposite nanofibers containing carbonaceous nanoparticles may be utilized. A smaller diameter of nanofibers and carbonaceous nanoparticles with high energy absorbance decrease the energy threshold required for carbonization.

A horizontal electrospinning apparatus may be used to spin out polymeric nanocomposite nanofibers. The electrospinning apparatus uses a high voltage power supply connected to the needles mounted on a syringe pump. The chassis of a pump and a rotating drum was grounded. The drum rotates at a constant speed while the chassis is connected to a resistor with high resistance (approximately 100 MΩ to maximize deposition on the drum and minimize fiber deposition elsewhere. A flow rate into the system is set to maintain a single droplet at the tip of the needles. The syringe pump is mounted on an XY stage programmed for oscillating motions to deposit fibers uniformly across the entire drum. Electrospinning is a cost-effective and facile alternative that can be used to produce nano-scale fibers and non-woven mats. Electrospinning enables control over the porosity and surface area of the resulting fiber mattress.

The mixture of polymers, carbonaceous nanocomposites, and solvents is spun out from the electrospinning process. Applicable polymers include one or more polyamides (PA), polyacrylamide (PAAm), polyurethane (PU), polybenzimidazole (PBI), polycarbonate (PC), polyethylene (PE), polyacrylonitrile (PAN), poly(methyl methacrylate) (PMMA), Polydiacetylene (PDA), polypropylene (PP), polystyrene (PS), polyethylene oxide (PEO), polyethylene naphthalate (PEN), polyethylene terephthalate (PET), polyvinylchloride (PVC), polyvinyl pyrrolidone (PVP), collagen, and cellulose acetate (CA).

The conductive carbon additives may include one or more single-walled carbon nanotubes (SWCNTs), multi-walled carbon nanotubes (MWCNTs), graphene, graphene oxides, graphene nanoplatelets (GNPs), and carbon dots.

The solvents may include but are not limited to combinations comprising of water, acetone, formic acid, chloroform, isopropanol, N-Methyl-2-pyrrolidone (NMP), Dimethylformamide (DMF), dimethyl sulfoxide (DMSO), and tetrahydrofuran (THF), depending on the polymers used.

Once the polymeric nanocomposite nanofibers are electrospun, the photoelectromagnetic energy can be used to carbonize them. In this process, spun-out fibers are irradiated with photoelectromagnetic energy while being placed on a substrate different from lithium metal anodes, and high-intensity IPL can be applied to completely carbonize the mattress of carbon fibers from both the top and bottom sides. Once the polymeric nanocomposite nanofibers are carbonized into the mattress of carbon fibers, it is transferred to the lithium metal anodes using a hot press technique with heat and pressure.

Photoelectromagnetic Energy Application Via Intense Pulsed Light (IPL)

The most critical step of creating a three-dimensional open-cell porous structure on the lithium metal anodes' coated film or a current collector is the energy application process. In a conventional method, the application of thermal energy via pyrolysis has been most common, but usually consumes large amounts of energy and time. Furthermore, since the process requires the application of energy to the lithium metal anodes' coated film, pyrolysis involving high temperature (400-800° C.) cannot be utilized due to a low melting point (180.5° C.) of lithium metal. In the present disclosure, a photoelectromagnetic energy application method, namely IPL and the like, is utilized to apply energy without damaging the lithium metal anode.

Intense pulsed light (IPL) utilizes rapid photo-electromagnetic waves generated from a xenon lamp. The application of a high-intensity pulse of electricity through a xenon gas-charged lamp results in photon irradiation as xenon gas is excited to a higher energy state then drops back to a lower state. The IPL technique has advantages over other electromagnetic energy application processes such as lasers and microwaves because it covers a large surface area within a short time (a few milliseconds).

Also, IPL has a broad spectrum of pulsed light, generally ranging from 200 to 1100 nm, whereas laser or microwave techniques have a more specific spectrum of wavelengths. Modern IPL devices utilize computer-controlled capacitor banks to generate IPL where its pulse duration, pulse intervals, number of pulses, and intensity are manipulated. Fluence (radiation energy received by a surface per unit area) is related to a distance from a source of energy to a target surface, an angle of reflectors, and the absorbance of the target surface.

As mentioned, carbon additives with high absorbance in a wide spectrum are present within a mixture encapsulating active materials and turn absorbed energy into thermal energy for the generation of a nanoporous structure. This means the energy efficiency of the IPL process is much higher and faster than that of the pyrolysis process. The high energy efficiency and short process time make this method more applicable to an existing large-scale battery manufacturing process involving the roll-to-roll manufacturing process.

Considering a typical IPL system, a diffusion depth of IPL irradiation is limited to approximately 1 μm from a surface. Such a limited diffusion depth may not be favorable if bulk material is to be processed. However, in the present disclosure, energy is delivered to the thin film and it is enough to create a desired effect on the coating. At the same time, the energy is not transferred to, or has a minimal effect on layers below the surface, avoiding damage to the lithium metal anode below the coating. This could also lead to an interesting effect, such as creating a gradient effect, as it was described in creating a gradient lithiophilic-lithiophobic layer of carbon nanotubes and metal oxides.

Anode-Less Copper Current Collector with Three-Dimensional Structure

Protective coatings with three-dimensional open-foam porous structures on lithium metal anodes have developed to prevent the growth of dendrites and excessive internal stress applied from volume change associated with lithiation cycles. However, because a lithiation process of lithium metal anodes is the electrodeposition of lithium ions, the question arose whether a lithium metal layer was necessary. A source of lithium ions was cathodes, and anodes were only needed to store lithium ions in the form of electrodeposited lithium. This led to the conclusion that an ‘anode-less’ current collector could function as an anode for lithium metal batteries.

For the ‘anode-less’ current collector to properly function, it required a scaffold or a structure capable of storing lithium ions during the lithiation process. Thus, a three-dimensional open-foam porous structure was again required on the current collector. The three-dimensional open-foam porous structure on the current collector provides the same benefits that protective coatings provide to the lithium metal anodes. It provides abundant nucleation points and space for lithium deposition during the lithiation cycle, preventing volume change and thus excessive internal stress. Additionally, the large surface area of the highly conductive material promotes the homogeneous distribution of charge, thus mitigating the formation of dendrites. If there is any mechanical stress, internally or externally, the three-dimensional structure of the current collector could act as a structural supporter to absorb the stress.

Various studies have been performed on the fabrication of three-dimensional structures or scaffolds for an anode-less current collector. They include creating a surface with high surface roughness, chemical and mechanical etchings of the surface of a current collector, constructing additional structures out of polymer, metals, or carbonaceous materials, and the like.

An example is a copper-carbon-frame three-dimensional structure constructed on a copper current collector [Chen et al. 2020]. The three-dimensional structure was fabricated by forming a carbon framework via pyrolysis of melamine-formaldehyde foam, then electroplating copper onto it. It achieved good electrical conductivity, increased surface area, had a stable SEI, and mitigated dendrites as its battery test results maintained 99.85% of its capacity after more than 300 cycles. However, to fabricate a carbon framework, it required a temperature of 900° C. for 2 hours in an N₂ atmosphere, then electroplating for 10 minutes using copper and CuSO₄ (copper sulfate) electrolytes, which is toxic.

In another example, a copper foam was prepared as the current collector, with reduced graphene oxide (rGO) adhering to them [Yu et al. 2019]. In the method, the manufacturing process involved immersing copper foam into a liquid with a graphene oxide suspension for 12 hours to achieve the reduced graphene oxides (rGO) covering the copper foam. A half-cell battery test using the rGO covered copper foam as an anode for a lithium metal battery revealed that its coulombic efficiency (CE) remained above 98.5% after 350 cycles. While the process was simple, it required long processing times (12 hours) and expensive, low-density copper foam.

Metal-Based Three-Dimensional Structure for Current Collector

In the present disclosure, proposed is a three-dimensional structure of a metal-based network, achieved by a method of film-coating metallic conductive ink followed by a photoelectromagnetic energy sintering process. The three-dimensional structure is composed mainly of conductive metal and a small number of additives.

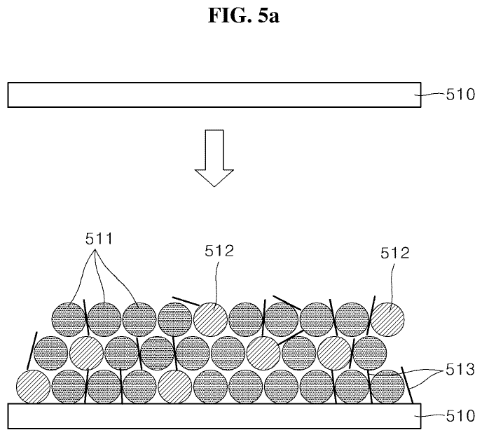

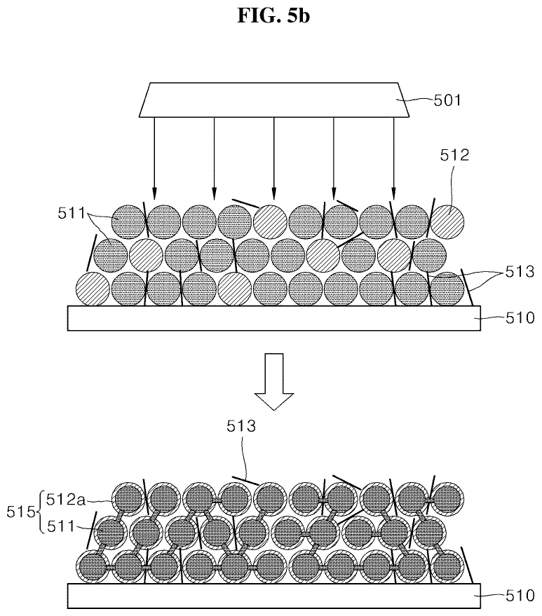

FIG. 5 schematically illustrates a process of fabricating conductive metallic three-dimensional structures on the current collector, with an example of copper-based conductive ink. Specifically, FIG. 5 shows a method of creating a three-dimensional structure of copper-silver-carbon on a copper current collector 510. Then during the charging process, the electroplating of lithium is performed to form lithium metal anodes.

In the embodiment, the current collector is made of copper. A conductive ink mixture is applied to the current collector and dried in a vacuum oven (see FIG. 5a). In the embodiment, the conductive ink mixture includes a solvent carrier, copper nanoparticles 511, silver nanoparticles 512, and conductive carbon additives 513, but is not limited. A variety of materials may be used at different ratios in specific applications.

The IPL irradiation equipment 501, for example, is used to irradiate photoelectromagnetic energy such that the copper nanoparticles are sintered, and a three-dimensional conductive network of copper nanoparticles 511, silver nanoparticles 512a, and conductive carbon additives 513 is formed on the current collector 510.

The three-dimensional conductive network formed on the current collector may be an anode electrode in itself. During a charging process, lithium is electroplated on the current collector on which the three-dimensional conductive network is formed, and as a result, a lithium metal anode electrode can be formed in a three-dimensional structure (see FIG. 5b).

The conductive metallic nanoparticles will be mainly copper-based nanoparticles, including but not limited to pure copper nanoparticles, copper formate, copper oxide, copper nitrate, copper nitrite, copper acetate nanoparticles, and coated nanoparticles with a protective layer of tin or a polymer. They are not conductive by themselves, but upon exposure to a critical amount of energy, the metallic nanoparticles melt instantaneously and form conductive bridges.

Polymeric carriers include, but are not limited to, diethylene glycol (DEG) and/or poly(N-vinylpyrrolidone) (PVP), both of which are commonly used conductive ink carriers. Additives can be metallic and non-metallic, and there is a specific purpose for the addition of each additive. Protective layers and additives surround a principal metallic conductor (i.e., copper nanoparticles) and fill a gap between nanoparticles. Additionally, they improve conductivity, remove and suppress oxidation, decrease the energy required for sintering, improve energy absorption, solderability, and adhesion characteristics, ensure protection from corrosion and abrasion, enhance a self-healing ability, and the like. These additives include but are not limited to, the following materials in various sizes: silver salts, tin, manganese, gallium, indium tin oxide, bismuth, zinc, lead, antimony, gold, silver, palladium, platinum, microfibers, carbon nanofibers, metal fibers, graphene, graphene nanoplatelets, and carbon nanotubes.

The mixture is prepared by stirring and sonication. Since the solvent and carrier polymers do not dissolve some of the main materials, sonication at an ultrasonic frequency is required to improve the dispersion of materials. Once the mixture of conductive ink is prepared, it is applied to the current collector via various film coating methods, including but not limited to bar coating, spray coating, doctor blading, and many others. Once the mixture is applied, it will go through a low-temperature (<50° C.) vacuum drying process to evaporate any remaining solvent.

Deposited conductive ink particles are not conductive immediately in the dried state, because they form a loose layer causing a gap between conductive metallic particles. Application of energy, ordinarily in form of heat, allows the nanoparticles to partially melt, resulting in the formation of a conductive bridge between the nanoparticles. There are conventional and pioneering techniques for sintering nanoparticles.

Conventional sintering methods of metal nanoparticles require temperatures ranging from 150 to 300° C. under inert gas environments. In addition, the preparation of such temperature and gas environments takes time and requires expensive equipment along with temperature-resistant substrates. These conditions can make the conventional sintering methods not ideal for practical applications.

In the present disclosure, the application of photoelectromagnetic energy is utilized to sinter the metallic particles. The method of applying photoelectromagnetic energy includes irradiating one or more IPL (intense pulsed light), a laser, IR (Infrared rays), and microwaves. The methods of applying photoelectromagnetic energy have several advantages over conventional pyrolysis or heat application. Above all, the application of photoelectromagnetic energy ensures higher energy efficiency. Unlike other heating methods where the temperature of the entire volume of a heating chamber must be increased, the application of photoelectromagnetic energy involves directly applying energy to a target surface. Additionally, energy absorption efficiency further increases by adding carbon additives, thereby reducing power consumption.

Furthermore, the photoelectromagnetic energy application method involves irradiating energy for only a short period. The IPL method utilizes a flash of xenon light for only a few milliseconds to cover a large surface area. The laser or microwave method may take a few seconds per irradiated area, which could still result in a high feed throughput in a roll-to-roll manufacturing process. Although the required power may be high, the total amount of energy required is much lower than conventional heat application processes due to a faster process time. Most importantly, the photoelectromagnetic energy application method is applicable without a major modification to existing anode manufacturing facilities as it does not require any chamber or an inert environment.

Carbon-Based Three-Dimensional Structure for Copper Current Collector Formed from Industrial by-Product

Carbon has become a favorable material for a three-dimensional structure attached to an anode-less current collector due to its high electrical conductivity, structural rigidity, and ease of the formation of three-dimensional structures.

Various carbon sources have been considered as potential candidates. For example, Aruna Zhamu and Bor Z. Jang of the Global Graphene Group described an anode electrode comprised of a lithium metal layer and a porous conductive layer made of graphene. The porous conductive layer increases surface area for the deposition of lithium and forms a stable SEI to reduce the formation of lithium dendrites. The electrical conductivity of the anode becomes more uniform, reducing lithium dendrites. The technology covers the fundamental structure of a three-dimensional structure coated on lithium metal anodes to prevent the growth of dendrites and catastrophic failure, but it does not include an efficient manufacturing process to form the structure.

Another example was done by Zhaohui Liao, Chariclea Scordilis-Kelley, and Yuriy Mikhaylik in 2012 describing a porous protective layer, generating uniformly dispersed lithium alloy and/or lithium nitride, for a lithium metal anode. This increases the diffusion capacity of lithium-ion and prevents the formation of lithium dendrites. The method uses cost-efficient materials to coat the lithium metal anode in a slurry and have it dried to form a protective layer. Materials for the protective layer are composed of a metal compound, a conductive agent, and a binder, where the metal compound is either metal nitride, aluminum oxide, or aluminum fluoride. This method involves creating the porous structure but is just limited to slurry deposition and a drying process. Moreover, the drying process requires 720 hours, making it time inefficient.

Another potential carbon precursor for the porous carbon structure is an industrial by-product such as asphaltene, pitch, cellulose, lignin, and the like. Asphaltene is an industrial by-product found in crude oil, and it is often removed due to its high viscosity and high carbon content which negatively affect production and energy efficiency as a fuel. Since it has been considered a waste material in the oil and gas industries, asphaltene is inexpensive and is in abundant supply. Utilizing asphaltene for the production of advanced lithium-ion batteries is advantageous economically and environmentally. Pitch is another high carbon content industrial by-product derived from petroleum, coal tar, or wood. Cellulose and lignin are high-carbon materials found in plants and by-products of the agricultural and forestry industry, such as rice husk, wheat, straw, and sawdust.

Others found the advantages of asphaltene as a carbon source to form a three-dimensional structure on current collectors. Wang and others used asphaltene to create ultrafast charging high-capacity lithium metal batteries [Wang et al. 2017]. In this study, they used untreated gilsonite as a carbon precursor. Gilsonite is a naturally generated black, solid, and lightweight material with high asphaltene content. The untreated gilsonite was pretreated at 400° C. for 3 hours under an argon-filled environment, and then it was grounded in a mortar with potassium hydroxide (KOH). The mixture was heated for 1 hour at 850° C., then filtered and washed with water and dried for 12 hours at 110° C. The KOH and pretreated gilsonite mixture, graphene nanoribbons (GNRs), and polyvinylidene difluoride (PVDF) were mixed in a mortar at a 4.5:4.5:1 mass ratio, and a slurry was formed as a result of the addition of an N-methyl-2-pyrrolidone (NMP) solvent. The slurry was coated on copper foil before being dried overnight in a vacuum at 50° C., resulting in a highly porous carbon structure called Asp-GNR-Li anode.

They found that the Asp-GNR-Li anode showed higher specific capacity compared to a conventional copper-lithium anode in all ranges of current density. Additionally, at a constant current density of 0.5 C, repeated charging and discharging cycles showed that the Asp-GNR-Li anode was maintained at 90% of specific capacity after 130 cycles, where the conventional copper-lithium anode dropped below 75% of specific capacity after 130 cycles. The trend showed that the specific capacity of the conventional copper-lithium anode was rapidly decreasing with an increase in the number of cycles.

The idea of utilizing high carbon content asphaltene as a precursor for the carbon structure had great potential, especially because of its cost-effectiveness and abundance of supply. However, the manufacturing process proposed in Wang and others' study involved many steps requiring high temperature and a long process time.

In the present disclosure, a new manufacturing technique utilizing the irradiation of photoelectromagnetic energy is suggested to create an anode-less current collector with a porous carbon structure on copper foil. As mentioned, the photoelectromagnetic energy application method has advantages over a conventional furnace heating process, as an energy-efficient and time-efficient process. The photoelectromagnetic energy application method is immediately applicable to a large-scale manufacturing process involving the roll-to-roll process, as it does not require any furnace, chamber, or inert environment.

In the method, a slurry mixture of a carbon precursor, a conductive carbon additive, and a solvent is prepared. The carbon precursor includes industrial by-products with high carbon content such as asphaltene, mesophase pitch, cellulose, cellulose nanocrystals, and lignin. The conductive carbon additives add structural rigidity, increase electrical conductivity, and increase energy absorbance for photoelectromagnetic energy. They include one or more combinations of carbon black, single-walled carbon nanotubes, multi-walled carbon nanotubes, functionalized carbon nanotubes, graphene, and graphene nanoplatelets. The slurry mixture is deposited on the copper foil using a thin-film coating method. Once the slurry is dried on the copper foil, photoelectromagnetic energy is applied to carbonize the slurry and form a three-dimensional carbon-based network structure. During the charging process, lithium may be electroplated on the surface of the three-dimensional carbon-based network structure.

Low-Melting Point Lithium Alloying Metal Coating

An additional layer of a low-melting-point lithium alloying metal coating could assist in stabilizing the solid electrolyte interphase (SEI) layer. This metallic coating could be applied either on the lithium metal layer, the protective coating, or on the anode-less current collector. It utilizes three different characteristics; high electrical conductivity, a fast-alloying reaction with lithium ions, and self-healing to stabilize the SEI layer.

Lithium alloying metals generally have a high electrical conductivity compared to copper and silver. Coating them on the lithium metal layer decreases contact resistance between the electrolyte and anode, thereby increasing the charge transfer rate. Studies have shown that the application of indium coating on lithium metal anodes results in a significant reduction in the electrical contact resistance between the electrolyte and anode [Choudhury et al. 2017].

Studies have also revealed that indium allows for the rapid diffusion of lithium ions via surface diffusion. Density-functional theory calculations were performed and indicated that indium has a small diffusion barrier on its surface. Lithium ions loosely bind to the indium coating and are rapidly transported over the indium coating to be electrodeposited on the underlying lithium metal layer [Choudhury et al. 2017]. Fast ionic conductivity also mitigates the formation of dendrites.

Lastly, metals like indium have a self-healing ability to maintain the SEI during the cycles of volumetric change because of lithiation and de-lithiation. In a liquid electrolyte environment, small traces of metallic salts could be added to the electrolyte to electroplate metals, repairing damaged metal coatings in the process. This is possible because indium is relatively inert to commonly used electrolytes, preventing side reactions and maintaining energy capacity over 90% of an original energy capacity after 250 charging and discharging cycles [Choudhury et al. 2017].

In a solid electrolyte environment, a lithium alloying metal coating utilizes its low melting point for self-healing. Field's metal is an alloy of bismuth, indium, and tin, each having a relatively high melting point of 271.4° C., 156.6° C., and 231.9° C. respectively, but the alloy has a melting point of only 62° C. The low melting point allows the metal coating to self-heal by passively using the heat generated by the internal resistance of the battery or by actively using the Joule heating system of the battery, commonly used to manage the temperature of the battery in a cold environment. The self-healing ability keeps the SEI layer stable throughout repeated cycles of charging and discharging, mitigates dendrites, and sustains the electrolyte and active materials.

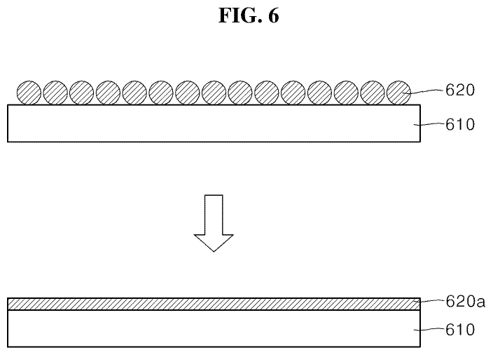

FIG. 6 schematically shows an example of a method of coating a lithium metal layer with lithium alloying metal to improve lithium-ion affinity and stabilize an SEI. Referring to FIG. 6, pulverized lithium alloying metal powder 620 is placed directly on a lithium metal layer 610. Then the lithium alloying metal powder is sintered by irradiating photoelectromagnetic energy. An instantaneous sintering process allows partially melted lithium alloying metal to be coated evenly on the surface of the lithium metal anode 610 and to form a lithium alloying metal coating 620a.

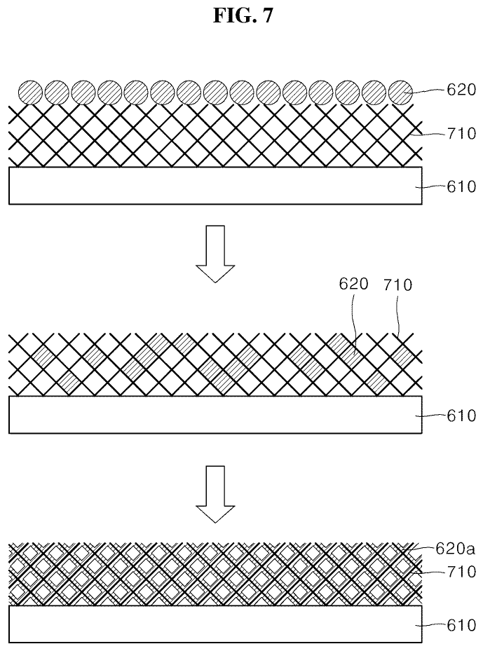

FIG. 7 schematically shows an example of a method of coating a three-dimensional structure with lithium alloying metal to improve lithium-ion affinity and stabilize an SEI. Referring to FIG. 7, pulverized lithium alloying metal powder 620 is placed on a three-dimensional structure 710 coated on a lithium metal layer 610. Then the lithium alloying metal powder 620 is calendered into a three-dimensional structure 710 coated on the lithium metal anode. Then photoelectromagnetic energy is applied to sinter the lithium alloying metal powder. An instantaneous sintering process allows partially melted lithium alloying metal to be coated evenly on the surface of the three-dimensional structure 710 and to form a lithium alloying metal coating 620a.

The low-melting-point lithium alloying metal coating can be directly applied onto the lithium metal layer, as illustrated in FIG. 6, or the three-dimensional open-cell porous protective coating on the lithium metal layer, as illustrated in FIG. 7.

Hereafter, an example of coating a lithium alloying metal on a lithium metal layer or a three-dimensional protective coating is described regarding FIG. 7. In the example, photoelectromagnetic energy is irradiated to melt lithium alloying metal powder within a short period while minimizing a thermal effect on the lithium metal layer under the lithium alloying metal powder and the melted lithium alloying metal powder is coated on the lithium metal layer or the three-dimensional protective coating. The method is different from conventional hot-melt dip coating or electro-deposition coating of metal.

In this embodiment, provided is a description of the formation of the low-melting-point lithium alloying metal coating in a simple method utilizing calendering, photoelectromagnetic energy application, and capillary action. First, low-melting-point lithium alloying metals are prepared in powder form. The low-melting-point lithium alloying metals may include but are not limited to, indium, tin, bismuth, gallium, silver, gold, zinc, aluminum, platinum, germanium, and a eutectic alloy such as Field's metal. Because of their highly malleable nature, these metals and metalloids may have to be freeze-milled to be finely powdered.

The metal powder could be randomly deposited on the surface of the three-dimensional protective coating and undergoes the calendering process by applying pressure and heat, so it penetrates the voids of the three-dimensional protective coating. As photoelectromagnetic energy is applied, the metal powder would melt and be wet by the three-dimensional structure as a result of capillary action. This procedure is possible because of the low melting points of these metals since a required temperature does not damage the substrate (i.e., a lithium metal layer with a protective coating).

To observe the effect of the suppression of lithium dendrite formation, samples of a three-dimensional structure of CNT networks with metal oxide were created. A mixture of carboxylic acid-modified CNTs (ACNTs), zinc oxide, and PVDF at a weight ratio of 2:3:5 was created by dissolving them in an NMP solvent. The mixture was mixed for 30 minutes using a planetary ball mixer and then coated on copper foil using a thin-film coating. Two samples with coatings of different thicknesses (70 μm and 100 μm) were created and dried in a vacuum oven at 40° C. for 2 hours. The dried samples were then irradiated with IPL at 2.3 kV of power to create a nanoporous structure.

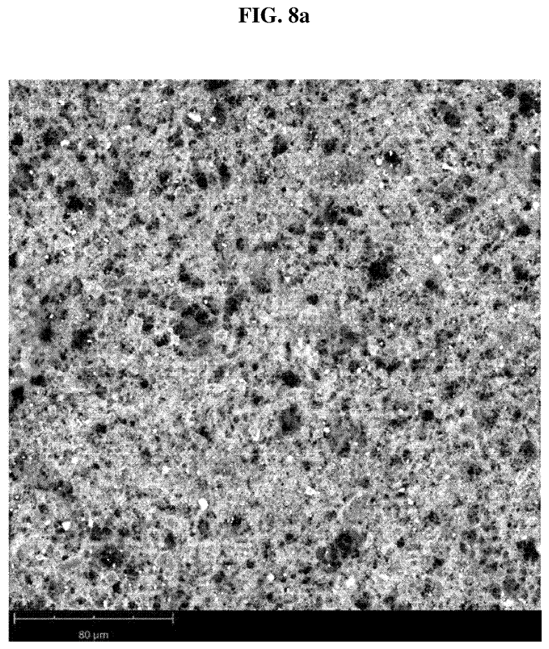

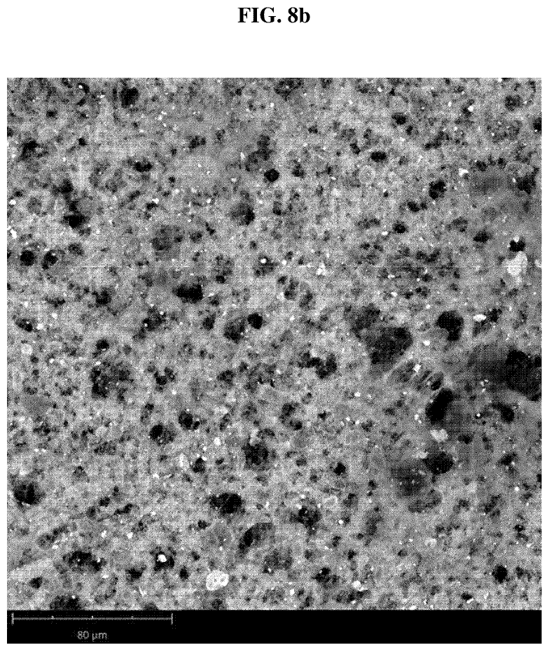

FIGS. 8a and 8b show the porosity of porous nanocomposite film samples that are 70 μm thick (a) and 100 μm thick (b) in scanning electron microscope (SEM) images. The SEM images of the surfaces of samples show both nano and micropores of samples having two different thicknesses.

Referring to FIG. 8a, the 70 μm-thick sample has pores of a maximum diameter of 15 μm. Referring to FIG. 8b, the 100 μm-thick sample has pores of a greater diameter of 20 μm.

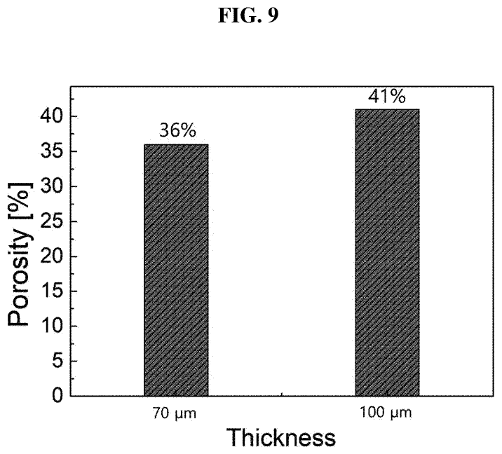

FIG. 9 shows the porosity of a porous nanocomposite film sample based on gas pycnometer analysis. Referring to FIG. 9, the porosity analysis using a gas pycnometer also showed that the 100 μm-thick sample had a porosity of 41%, which was larger than the 36% porosity of the 70 μm-thick sample (See FIG. 8.). Although the two samples had the same composition, a difference in the thickness resulted in different porosity. The increased porosity resulting from the increased thickness could relate to a drying process, where a thicker sample might have had some residual solvent, resulting in increased porosity.

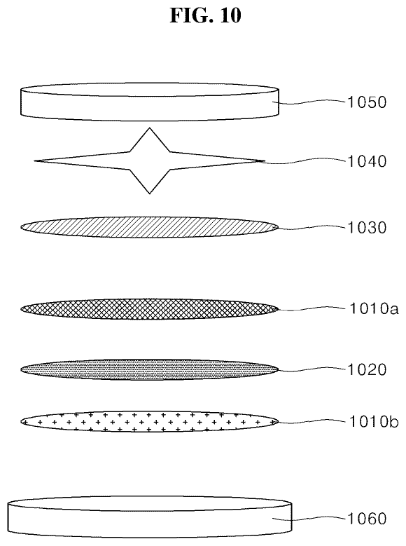

Samples of nanocomposite coatings on lithium metal anodes were tested using the symmetric cell test as shown in FIG. 10. In the symmetric cell test, a pair of lithium metal electrodes 1010a, 1010b are placed instead of an anode and a cathode. A separator 1020 is disposed between the pair of lithium metal electrodes 1010a, 1010b. A spacer 1030, spring 1040, and an upper cap 1050 are consecutively placed on one lithium metal electrode 1010a, and a lower cap 1060 is placed under the other lithium metal electrode 1010b. Under constant current density, the voltage over time is monitored throughout charging and discharging cycles. If the amplitude of voltage increases and reaches a critical limit, it is concluded that lithium dendrites are formed, and a cell fails.

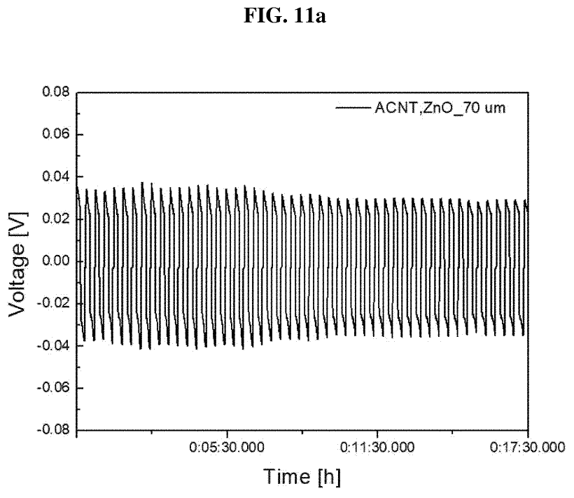

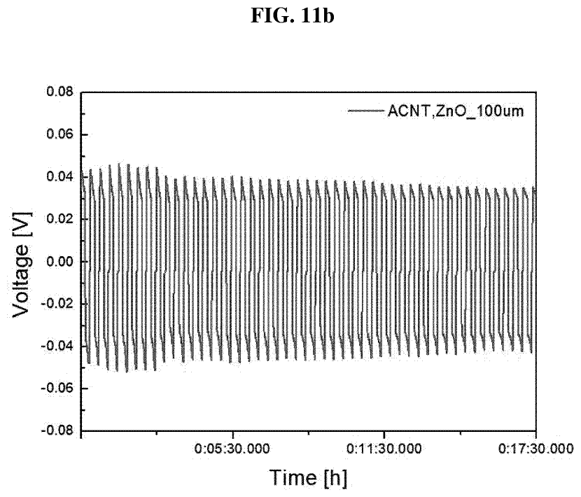

FIGS. 11a and 11b show results of analysis of the stability of the lithium metal anodes of porous nanocomposite film samples. Samples of different thicknesses (70 μm and 100 μm) consisting of PVDF, ZnO, and CNT were analyzed using the symmetric cell test.

Referring to FIGS. 11a and 11b, in the voltage graph, the two samples having different thicknesses (70 μm and 100 μm) show stable cycles under the density of 0.5 mA/cm². This clearly shows that the formation of lithium dendrites is effectively suppressed in the two samples. Unlike the 70 μm-thick sample in FIG. 11a, the 100 μm-thick sample in FIG. 11b has an increased amplitude (an increase of about 15%) of voltage while showing similar stability to the 70 μm-thick sample. The increased amplitude of voltage indicates that the 100 μm-thick sample has higher porosity and volume than the 70 μm-thick sample, suggesting a higher energy capacity.

In an exemplary case, the copper nanoparticles (Cu NPs) having an average diameter of 100 nm (Tekna) are mixed with silver nitrate (AgNO₃), poly-(N-vinylpyrrolidone) (PVP), MW: 40,000 g/mol), diethylene glycol (DEG), graphene nanoplatelets (GnPs, specific surface area: 500 m²/g), and formic acid (HCOOH). The doctor blading method was applied to deposit ink onto a substrate made of 3D-printed Acrylonitrile Butadiene Styrene (ABS) for testing purposes. The coated film was dried at 50° C. in a vacuum oven for one hour to remove any residual solvents. The conductive ink film was then sintered using IPL treatment to form a conductive network between deposited particles. The intensive light pulse from the Xenon flash tube (Cerium Type A) sintered the sample with two different square-shaped pulses of 1 ms and 2.5 ms duration, corresponding to the energy density of 1.07 to 3.66 J/cm².

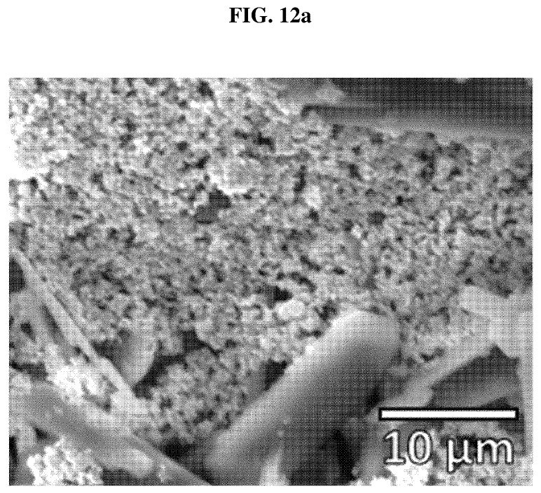

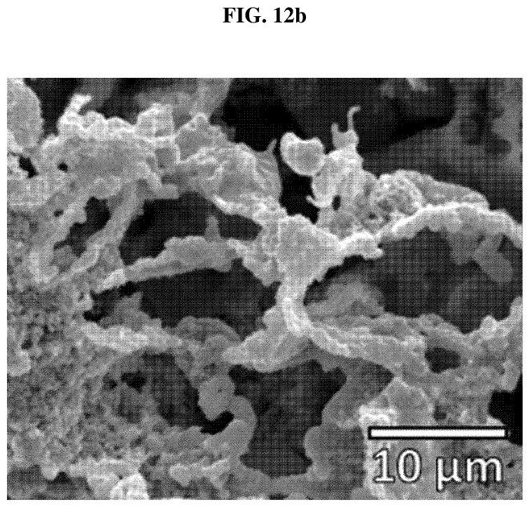

FIGS. 12a and 12b show results of comparison of surface morphology of a copper-based metal conductive ink before and after the irradiation of photoelectromagnetic energy using a scanning electron microscope (SEM).

Referring to FIG. 12a, before the application of IPL, the surface of the coated copper-based metal conductive ink is no more than clumped metal nanoparticles and crystallized metal oxide. However, referring to FIG. 12b, after the application of IPL, the metal oxide is reduced to metal and forms a thinly sintered copper conductive network having a highly porous three-dimensional structure.

The subject matter according to the present disclosure can be summed up as follows.

An anode electrode for a lithium metal battery, having the functions of suppressing the growth of dendrites, maintaining a stable SEI, and withstanding internal stress of volume change in lithium metal throughout repeated cycles of charging and discharging comprises of i. a copper current collector layer, ii. a lithium metal layer placed on the surface of the current collector layer, iii. a protective layer in a three-dimensional structure having open-cell pores, and iv. a low-melting-point lithium alloying metal coating.

The lithium metal layer has an engineered surface texture to enhance adhesion with a protective layer.

The engineered surface texture is created using a sandblasting method of shooting abrasive particles at the lithium metal layer.

The abrasive particles include but are not limited to, one or more aluminum oxide, ground silica, and chemically inert soda-lime glass beads.

The protective layer is comprised of a polymeric nanocomposite material including an open-cell nanoporous polymer matrix, carbon-based conductive nano-materials, and structural support materials.

A method of forming the polymeric nanocomposite layer having an open-cell nanoporous structure comprising of i. mixing precursor materials of polymer nanocomposites to form a slurry, ii. coating the slurry on the lithium metal layer using a thin-film coating method and drying it, and iii. applying photoelectromagnetic energy to evaporate low-melting-point polymers in the slurry to form three-dimensional open-cell nanopores.

The mixture of the polymer nanocomposite slurry comprises two or more polymers having distinctive boiling points, conductive carbon additives, structural support materials, and a solvent, the two or more polymers having distinctive boiling points are selected unlimitedly from polyacrylonitrile (PAN), Polytetrafluoroethylene (PTFE), poly(methyl methacrylate) (PMMA), poly(3,4-ethylene dioxythiophene) polystyrene sulfonate (PEDOT: PSS), Polydiacetylenes (PDAs), polypropylene, polystyrene (PS), polyurethane (PU), polyethylene oxide (PEO), polyethylene terephthalate (PET), Styrene-ethylene-butylene-styrene (SEBS), glycerol, sucrose, cellulose, and lignin.

The structural support additives include materials having high mechanical strength and electrochemically inert materials such as hexagonal boron nitride (hBN), silicon nanowires (SiNW), and aluminum oxides among others.

The conductive carbon additives are selected unlimitedly from single-walled carbon nanotubes (SWCNTs), multi-walled carbon nanotubes (MWCNTs), graphene, graphene oxides, graphene nanoplatelets (GNP), and carbon dots.

The solvents include but are not limited to, water, N-Methyl-2-pyrrolidone (NMP), Dimethylformamide (DMF), dimethyl sulfoxide (DMSO), or a combination thereof.

The protective layer includes a mattress of carbon nanofibers having a three-dimensional open-cell porous structure.

A method of creating the mattress of carbon nanofibers having an open-cell nanoporous structure comprises i. preparing a solution of nanofiber precursors, ii. electrospinning a mattress of polymer nanocomposite nanofibers, iii. applying photoelectromagnetic energy to carbonize the polymer nanocomposite nanofibers and form carbon nanofibers, and iv. hot pressing the mattress of polymer nanocomposite nanofibers to a lithium metal anode.

The nanofiber precursor solution includes a mixture comprising of one or more polymers suitable for electrospinning conductive carbon additives and solvents.

The polymers are selected unlimitedly from polyamides (PA), polyacrylamide (PAAm), polyurethane (PU), polybenzimidazole (PBI), polycarbonate (PC), polyethylene (PE), polyacrylonitrile (PAN), poly(methyl methacrylate) (PMMA), Polydiacetylenes (PDAs), polypropylene (PP), polystyrene (PS), polyethylene oxide (PEO), polyethylene naphthalate (PEN), polyethylene terephthalate (PET), polyvinylchloride (PVC), polyvinyl pyrrolidone (PVP), collagen, and cellulose acetate (CA).

The conductive carbon additives include but are not limited to, one or more single-walled carbon nanotubes (SWCNTs), multi-walled carbon nanotubes (MWCNTs), graphene, graphene oxides, graphene nanoplatelets (GNPs), and carbon dots.

The solvents include but are not limited to, one or more water, acetone, formic acid, chloroform, isopropanol, N-Methyl-2-pyrrolidone (NMP), Dimethylformamide (DMF), dimethyl sulfoxide (DMSO), and tetrahydrofuran (THF).

The electrospinning process involves forming voltage differences between the needles of syringes mounted on a syringe pump and a rotating drum, using a horizontal electrospinning apparatus with a high voltage power supply.

In the step of adhering the mattress of carbon nanofibers, heat and compressive stress are applied together to adhere the mattress to the lithium metal layer, and the heat and compressive stress are applied unlimitedly via a calendering machine, a compression molding machine, and a hot press.

The protective layer is comprised of a network of carbon nanotubes coated with metal oxides and has a three-dimensional open-cell porous structure.

A method of creating the network of carbon nanotubes coated with metal oxides comprises i. mixing a nanocomposite precursor of lithiophilic metal oxides and lithiophobic carbon nanotubes, ii. depositing the nanocomposite of lithiophilic metal oxides and lithiophobic carbon nanotubes on the lithium metal layer using thin-film coating, and iii. applying photoelectromagnetic energy to form a network of carbon nanotubes with gradient lithiophilic-lithiophobic properties, where a top layer of the carbon nanotube network is lithiophobic carbon nanotubes and a bottom layer is lithiophilic metal oxide-carbon nanotube composites.

The mixture of nanocomposite precursors is comprised of lithiophilic metal oxides to adhere carbon nanotubes to the lithium metal anode and maintain a network structure, and lithiophobic carbon nanotubes to form a conductive network.

The lithiophilic metal oxides may include, but not be limited to, zinc oxide, iron oxide, manganese oxide, and titanium oxide.

The carbon nanotubes may include, but not be limited to, single-walled CNTs (SWCNTs), double-walled CNTs (DWCNTs), multi-walled CNTs, functionalized CNTs, or short carbon nanofibers.

The solvents may include but are not limited to, water, ethanol, hexane, N-Methyl-2-pyrrolidone (NMP), Dimethylformamide (DMF), dimethyl sulfoxide (DMSO), or a combination thereof.

A current collector having the functions of suppressing the growth of dendrites, maintaining a stable SEI, and withstanding internal stress of volume change in lithium metal throughout repeated cycles of charging and discharging comprises i. a copper metal current collector layer, ii. a three-dimensional network structure coated on the copper metal current collector layer where the three-dimensional network structure is based on copper or carbon.

A method of creating a three-dimensional open-cell copper-based network structure comprises i. forming a slurry in which copper, silver, conductive carbon additives, polymeric carriers, and solvents are mixed, ii. depositing the slurry on a copper metal layer using thin-film coating, and iii. photo electromagnetically sintering the deposited slurry to form a three-dimensional copper-based network structure.

The slurry includes copper-based nanoparticles, silver salts, polymeric carriers, conductive carbon additives, and solvents.

The copper-based nanoparticles are comprised of one or more selected unlimitedly from copper, copper acetate, copper oxide, and copper formate tetrahydrate.

The silver salts are comprised of one or more selected unlimitedly from silver, silver nitrate, silver nitrite, and silver acetate.

The polymeric carrier includes polyvinylpyrrolidone dissolved in polyethylene glycol.

The conductive carbon additives are comprised of one or more selected from carbon black, single-walled carbon nanotubes, multi-walled carbon nanotubes, functionalized carbon nanotubes, graphene, and graphene nanoplatelets.

A method of creating a three-dimensional open-cell carbon-based network structure comprises i. mixing carbon precursors, conductive carbon additives, and solvents to form a slurry, ii. Depositing the slurry on a copper metal layer using thin-film coating, and iii. Applying photoelectromagnetic energy to carbonize the slurry and form a three-dimensional carbon-based network structure.

The mixture comprises one or more carbon precursors, conductive carbon additives, and solvents.

The carbon precursors include industrial by-products such as asphaltene, mesophase pitch, cellulose, cellulose nanocrystals, and lignin.

The conductive carbon additives are comprised of carbon black, single-walled carbon nanotubes, multi-walled carbon nanotubes, functionalized carbon nanotubes, graphene, graphene nanoplatelets, or a combination thereof.

The low-melting-point lithium alloying metal coating has a self-healing ability and is applied to the surface of a lithium metal anode, the protective coating, or the anode-less current collector to stabilize a solid-electrolyte interface layer.

A method of creating the lithium alloying metal coating on the protective coating of the lithium metal anode comprises i. adding pulverized powder of lithium alloying metal on the lithium metal layer, the protective coating, or the anode-less current collector, and ii. Applying photoelectromagnetic energy to sinter a thin lithium alloying metal on a lithium target surface.

The pulverized powder includes one or more low-melting-point lithium alloying metals and metalloids.

The low-melting-point lithium alloying metals and metalloids are selected unlimitedly from indium, tin, bismuth, gallium, silver, gold, zinc, aluminum, platinum, germanium, and Field's metal.

A method of depositing materials using thin-film coating comprises coating a slurry mixture of nanocomposite materials with a film coater that may be a wire coater or blade coater and drying the coated slurry in a vacuum oven to evaporate all the solvents in the slurry.

A method of applying photoelectromagnetic energy comprises vaporizing low-boiling point materials, inducing carbonization of polymer and carbon precursor materials, and sintering conductive metal nanoparticles.

The application of photoelectromagnetic energy involves applying high energy within a short time and absorbing the applied energy by carbon additives at a high absorption rate.

The application of photoelectromagnetic energy involves applying energy only to an irradiated surface.

The application of photoelectromagnetic energy involves irradiation via intense pulsed light (IPL), microwaves, lasers, plasma, or an infrared oven.

A cooling apparatus for cooling a substrate during the application of photoelectromagnetic energy lowers the temperature of the substrate in contact with materials under the direct irradiation of photoelectromagnetic energy, such as the lithium metal layer or a copper current collector layer, to prevent excess heat from damaging the substrate.

The cooling apparatus comprises i. a holder plate with a thermally conductive metal and ii. a heat exchanger system such as Peltier elements or a heat exchanger system allowing coolants to run through the holder plate and be pumped into the heat exchanger.

The holder plate comprises a metal plate with extruded fixtures to fit the lithium metal anode of a designated size, the metal plate is thick enough to hold the heat exchanger system, and materials for the metal plate include but are not limited to, copper or aluminum.

1.-10. (canceled)

11. A method of manufacturing an anode electrode for a lithium metal battery, comprising:
disposing a lithium metal layer on a current collector;
forming a protective layer having a three-dimensional open-cell porous structure on the lithium metal layer; and
forming a lithium alloying metal layer on a surface of the protective coating,
wherein at least one of the steps of forming a protective coating and forming a lithium alloying metal coating comprises irradiating photoelectromagnetic energy.

12. The method of claim 11, wherein the step of forming the protective layer comprises:
generating a slurry in which a first polymer, a second polymer having a lower boiling point than the first polymer, a conductive carbon additive, a structural support additive, and a solvent are mixed,
coating the slurry on the lithium metal layer and then drying it to form an intermediate coating, using a thin-film coating, and
irradiating photoelectromagnetic energy to the intermediate coating and vaporizing the second polymer in the intermediate coating to form nanopores.

13. The method of claim 12, wherein the first polymer and the second polymer is selected from polyacrylonitrile (PAN), Polytetrafluoroethylene (PTFE), poly(methyl methacrylate) (PMMA), poly(3,4-ethylene dioxythiophene) polystyrene sulfonate (PEDOT: PSS), Polydiacetylenes (PDAs), polypropylene, polystyrene (PS), polyurethane (PU), polyethylene oxide (PEO), polyethylene terephthalate (PET), Styrene-ethylene-butylene-styrene (SEBS), glycerol, sucrose, cellulose, and lignin,
the conductive carbon additive is selected from single-walled carbon nanotubes (SWCNTs), multi-walled carbon nanotubes (MWCNT), graphene, graphene oxides, graphene nanoplatelets (GNP), and carbon dots, and
the structural support additive is selected from hexagonal boron nitride (hBN), silicon nanowires (SiNW), and aluminum oxides.

14. The method of claim 11, wherein the step of forming a protective coating comprises:
preparing a nanofiber precursor solution,
electrospinning the nanofiber precursor solution to a mattress of polymer nanocomposite nanofibers,
applying photoelectromagnetic energy to the polymer nanocomposite nanofibers to carbonize the polymer nanocomposite nanofibers and form a mattress of carbon nanofibers, and attaching the mattress of carbon nanofibers to lithium metal anodes.

15. The method of claim 14, wherein the nanofiber precursor solution comprises polymers, conductive carbon additives, and solvents,
wherein the polymers comprise one or more of polyamides (PA), polyacrylamide (PAAm), polyurethane (PU), polybenzimidazole (PBI), polycarbonate (PC), polyethylene (PE), polyacrylonitrile (PAN), poly(methyl methacrylate) (PMMA), Polydiacetylenes (PDAs), polypropylene (PP), polystyrene (PS), polyethylene oxide (PEO), polyethylene naphthalate (PEN), polyethylene terephthalate (PET), polyvinylchloride (PVC), polyvinyl pyrrolidone (PVP), collagen, and cellulose acetate (CA),
wherein the conductive carbon additives comprise one or more of single-walled carbon nanotubes (SWCNT), multi-walled carbon nanotubes (MWCNT), graphene, graphene oxides, graphene nanoplatelets (GNP), and carbon dots, and
wherein the solvents comprise one or more of water, acetone, formic acid, chloroform, isopropanol, N-Methyl-2-pyrrolidone (NMP), Dimethylformamide (DMF), dimethyl sulfoxide (DMSO), and tetrahydrofuran (THF).

16. The method of claim 14, wherein the step of attaching a mattress of carbon nanofibers comprises applying heat and compressive stress together to adhere the mattress of carbon nanofibers to the lithium metal layer, and
the heat and compressive stress are applied via calendering machine, compression molding machine, and hot press.

17. The method of claim 11, wherein the steps of forming a protective coating comprises mixing a nanocomposite precursor of lithiophilic metal oxides and lithiophobic carbon nanotubes in a solvent,
depositing the nanocomposite of lithiophilic metal oxides and lithiophobic carbon nanotubes on a lithium metal layer, using thin-film coating,
applying photoelectromagnetic energy to rapidly dry solvent and form a network of carbon nanotubes with gradually increasing lithiophilic metal oxides concentration from the top to the bottom,
wherein the top layer of the network of carbon nanotubes is a lithiophobic carbon nanotube and the bottom layer is a lithiophilic metal oxide-carbon nanotube composite, wherein the lithiophilic metal oxides comprise one or more of zinc oxide, iron oxide, manganese oxide, and titanium oxide, and
wherein the carbon nanotube comprises single-walled CNTs (SWCNTs), double-walled CNTs (DWCNTs), multi-walled CNTs, functionalized CNTs, or short carbon nanofibers, and
the solvent comprises water, ethanol, hexane, N-Methyl-2-pyrrolidone (NMP), Dimethylformamide (DMF), dimethyl sulfoxide (DMSO), or a combination thereof.

18. The method of claim 14, wherein coating lithium alloying metal on the protective layer comprises depositing powdered lithium alloying metal on the protective coating, allowing the powdered lithium alloying metal to penetrate the protective coating through the porous structure using a calendering process, irradiating photoelectromagnetic energy to melt the powdered lithium alloying metal, and coating the melted lithium alloying metal on a surface of the protective coating based on capillary action.

19. The method of claim 11, wherein the method further comprises forming an engineered surface texture on the lithium metal layer, using sandblasting,
wherein the abrasives used for sandblasting comprises aluminum oxide, ground silica, or soda-lime glass beads, ranging from 1 to 100 μm.

20. A method of manufacturing an anode electrode for a lithium metal battery, comprising:
forming a slurry in which one or more metallic nanoparticle precursors, a conductive carbon additive, a polymeric carrier, and a solvent are mixed;
depositing the slurry on a metal current collector using thin-film coating;
irradiating photoelectromagnetic energy to sinter the deposited slurry; and
sintering the slurry as a result of the irradiation of photoelectromagnetic energy to form a three-dimensional metal-based network structure.

21. The method of claim 20, wherein the metallic nanoparticle precursors comprise copper-based nanoparticle precursors and silver salts,
wherein the copper-based nanoparticle precursor is one or more selected from copper, copper acetate, copper oxide, and copper formate tetrahydrate,
wherein the silver salts comprise of one or more combinations of nanoparticles including silver, silver nitrate, silver nitrite, silver acetate, and silver salts,
wherein the conductive carbon additive comprises of one or more combinations of carbon black, single-walled carbon nanotubes, multi-walled carbon nanotubes, functionalized carbon-nanotubes, graphene, and graphene nanoplatelets,
wherein the polymeric carrier comprises a combination of polyvinylpyrrolidone (PVP) dissolved in polyethylene glycol (PEG), and
wherein the solvent comprises of one or more combination of water, de-ionized water, alcohol, formic acid, nitric acid or sulfuric acid.

22. The method of claim 20, further comprising coating lithium alloying metal on three-dimensional metal-based network structure, comprising depositing powdered lithium alloying metal on the three-dimensional metal based structure, allowing the powdered lithium alloying metal to penetrate the three-dimensional metal based structure through the porous structure using a calendering process, irradiating photoelectromagnetic energy to melt the powdered lithium alloying metal, and coating the melted lithium alloying metal on a surface of the three-dimensional carbon-based network structure based on capillary action.

23. A method of manufacturing an anode electrode for a lithium metal battery, comprising:
mixing a carbon precursor, a conductive carbon additive, and a solvent to generate a slurry;
depositing the slurry on a metal current collector using thin-film coating; and
applying photoelectromagnetic energy to the deposited slurry to carbonize the slurry and form a three-dimensional carbon-based network structure.

24. The method of claim 23, wherein the carbon precursor is selected from asphaltene, mesophase pitch, cellulose, cellulose nanocrystals, and lignin,
wherein the conductive carbon additive comprises of one or more combinations of carbon black, single-walled carbon nanotubes, multi-walled carbon nanotubes, functionalized carbon-nanotubes, graphene, and graphene nanoplatelets, and
wherein the solvent comprises of one or more combination of water, de-ionized water and alcohol.

25. The method of claim 23, further comprising coating lithium alloying metal on the three-dimensional carbon-based network structure, comprising depositing powdered lithium alloying metal on the three-dimensional carbon-based network structure, allowing the powdered lithium alloying metal to penetrate the three-dimensional carbon-based network structure through the porous structure using a calendering process, irradiating photoelectromagnetic energy to melt the powdered lithium alloying metal, and coating the melted lithium alloying metal on a surface of the three-dimensional carbon-based network structure based on capillary action.

26. The method of claim 11, wherein the photoelectromagnetic energy application evaporates low boiling point materials, induces carbonization of polymer and carbon precursor materials, and sinters conductive metal nanoparticles,
wherein the photoelectromagnetic energy application applies high energy in a short time, absorbed with a high absorption rate by carbon additives, and applies energy to the irradiated surface only,
wherein the application of photoelectromagnetic energy uses irradiation via intense pulsed light (IPL), microwaves, laser, plasma or infrared oven.

27. (canceled)

28. The method of claim 20, wherein the photoelectromagnetic energy application evaporates low boiling point materials, induces carbonization of polymer and carbon precursor materials, and sinters conductive metal nanoparticles,
wherein the photoelectromagnetic energy application applies high energy in a short time, absorbed with a high absorption rate by carbon additives, and applies energy to the irradiated surface only,
wherein the application of photoelectromagnetic energy uses irradiation via intense pulsed light (IPL), microwaves, laser, plasma or infrared oven.

29. The method of claim 23, wherein the photoelectromagnetic energy application evaporates low boiling point materials, induces carbonization of polymer and carbon precursor materials, and sinters conductive metal nanoparticles,
wherein the photoelectromagnetic energy application applies high energy in a short time, absorbed with a high absorption rate by carbon additives, and applies energy to the irradiated surface only,
wherein the application of photoelectromagnetic energy uses irradiation via intense pulsed light (IPL), microwaves, laser, plasma or infrared oven.
